(19) United States
(12) Patent Application Publication
(10) Pub. No.: US 2025/0205591 A1
(43) Pub. Date: Jun. 26, 2025

(54) LOTTERY DEVICE AND LOTTERY GAME DEVICE

(71) Applicant: SEGA CORPORATION, Tokyo (JP)

(72) Inventors: Yuusuke Kaji, Tokyo (JP); Satoshi Doi, Tokyo (JP)

(73) Assignee: SEGA CORPORATION, Tokyo (JP)

(21) Appl. No.: 19/077,773

(22) Filed: Mar. 12, 2025

Related U.S. Application Data
(63) Continuation of application No. PCT/JP2023/026294, filed on Jul. 18, 2023.

(30) Foreign Application Priority Data
Sep. 16, 2022 (JP) 2022-148463

(51) Int. Cl. A63F 5/02

(52) U.S. Cl. CPC A63F 5/02

(57) ABSTRACT

A lottery device includes: a lottery table including a rotary disk on which a ball is placed, wherein a lottery hole, into which the ball can drop, is formed in a center of the rotary disk; a rotational driver that drives the rotary disk in a first rotation direction such that the ball placed on the rotary disk rotates in the first rotation direction; and a rotation imparting elastomer that applies an external force on the ball to rotate in a second rotation direction while maintaining rotation of the ball in the first rotation direction. In the first rotation direction, the ball rotates around a rotation axis of the rotary disk, and in the second rotation direction, the ball rotates around a center axis passing through a center of the ball.

### BACKGROUND

### Technical Field

The present invention relates to a lottery device and a lottery game device.

### Description of Related Art

Conventionally, various kinds of roulette-type lottery devices have been proposed and commercialized, in which a lottery is conducted by placing a ball on a rotary disk that acts as an agitator, and the rotation of the rotary disk causes the ball to spin around the disk and land in a pocket on a roulette wheel (see, for example, Patent Literature 1).

### PATENT LITERATURE

Japanese Patent No. 6799237

### TECHNOLOGICAL PROBLEM TO BE SOLVED BY THE INVENTION

In the conventional lottery device disclosed in Patent Literature 1, the rotation directions of the wheel body and the rotary disk are reversed to extend the time in which the ball remains on the rotary disk. However, the conventional lottery device disclosed in Patent Literature 1 rotates the ball in only one direction. As a result, the movement of the ball on the rotary disk ends up being monotonous, and in particular there is very little movement in the vicinity of the drop holes, reducing the amount of time in which the game feels compelling since the amount of time the ball spends on the rotary disk ends up being predictable. Consequently, there is a risk that the player player's anticipation for the lottery may be diminished and the lottery game would lose its entertainment value.

### SUMMARY

One or more embodiments of the present invention provide a lottery device and a lottery game device with which, using a simple configuration, it is possible to introduce variability into the movement of the ball on the rotary disk, thereby extending the period during which the ball's movement is particularly captivating, and thus increasing the player's anticipation for the lottery and the entertainment value of the lottery game.

The lottery device according to an aspect of the present invention comprises a lottery table comprising a rotary disk on which a ball is placed, wherein a lottery hole, into which the ball can drop, is formed in a center of the rotary disk; a rotational driver that drives the rotary disk in a first rotation direction such that the ball placed on the rotary disk rotates in the first rotation direction; and a rotation imparting elastomer that applies an external force on the ball to rotate in a second rotation direction while maintaining rotation of the ball in the first rotation direction. In the first rotation direction, the ball rotates around a rotation axis of the rotary disk, and in the second rotation direction, the ball rotates around a center axis passing through a center of the ball.

Employing this configuration makes it possible to use a simple structure to introduce variability into the movement of the ball on the rotary disk, thereby extending the period during which the ball's movement is particularly captivating, and thus increasing the player's anticipation for the lottery and the entertainment value of the lottery game.

In the lottery device according to an aspect of the present invention, the rotary disk may have a placement surface on which the ball is placed, the placement surface may be inclined such that the ball moves, while rotating, from a peripheral edge portion of the placement surface toward a center portion of the placement and falls into the lottery hole.

Employing this configuration makes it easier to ensure that the ball does not drop into the lottery hole too quickly while it is rotating.

In the lottery device according to an aspect of the present invention, the first rotation direction and the second rotation direction may each be either clockwise or counterclockwise, and the rotational driver may drive the rotary disk to rotate in the first rotation direction and then in the second rotation direction.

Employing this configuration increases the variability in the amount of time of the ball spends on the agitation surface, and the movement in the vicinity of the lottery openings can be made more random.

In the lottery device according to an aspect of the present invention, the rotary disk may have a placement surface on which the ball is placed, the placement surface may have a guide portion that guides the movement of the ball between a peripheral edge portion and a center portion of the placement surface, and the guide portion may guide a first movement of the ball during rotation of the rotary disk in the first rotation direction such that the ball moves away from the center portion along the guide portion while maintaining the first rotation and the second rotation of the ball.

Employing this configuration allows the ball to be moved away from the lottery hole, and the rolling time of the ball on the rotary disk to be extended.

In the lottery device according to an aspect of the present invention, the rotational driver may rotate the rotary disk in the first rotation direction and then in the second rotation direction, and the guide portion may guide a second movement of the ball during rotation of the rotary disk in the second rotation direction such that the ball approaches the center portion along the guide portion while maintaining the first rotation and the second rotation of the ball.

Employing this configuration makes it possible to decrease the rotation speed of the ball and ensure that the ball does not drop into the lottery hole too quickly.

In the lottery device according to an aspect of the present invention, a guiderail may be further disposed around the rotary disk to limit a range of the first rotation of the ball to within the rotary disk through contact with the ball, and the rotation imparting elastomer may be attached to the guiderail.

Employing this configuration allows for the attachment of the rotation imparting elastomer to be simplified.

In the lottery device according to an aspect of the present invention, the rotation imparting elastomer may cause the second rotation of the ball by using a frictional force generated by the contact with the ball.

Employing this configuration makes it possible to achieve the second rotation of the ball using a simple structure.

In the lottery device according to an aspect of the present invention, a conveyance unit may be further provided that conveys the ball in the lottery hole to the placement surface of the rotary disk, wherein the conveyance unit is movable in an up and down direction to: in response to the rotary disk starting to rotate in the first rotation direction after the ball has been conveyed to the placement surface, cover an opening of the lottery hole on a rotary disk side to prevent the ball from entering the lottery hole, and after a predetermined time has elapsed since start of the rotation of the rotary disk in the first rotation direction, open the opening to allow the ball to drop into the lottery hole.

Employing this configuration makes it easy to convey the ball and also makes it less likely that the ball will drop into the lottery hole at an early stage.

The lottery game device according to an aspect of the present invention comprises a media acceptance unit that receives game media through operations by a player, a second lottery machine which is an example of the above-mentioned lottery device that starts a lottery game featuring a ball in response to the media acceptance unit receiving real game media or virtual game media, and a media payout unit that pays out to the player real game media or virtual game media corresponding to a lottery result obtained by the second lottery machine. As a result, using a simple configuration, it is possible to introduce variability into the movement of the ball during a lottery game, thereby extending the period during which the ball's movement is particularly captivating, and thus increasing the player's anticipation for the lottery and the entertainment value of the lottery game.

With one or more embodiments of the present invention, it is possible to provide a lottery device and a lottery game device with which, using a simple configuration, it is possible to introduce variability into the movement of the ball on the rotary disk, thereby extending the period during which the ball's movement is particularly captivating, and thus increasing the player's anticipation for the lottery and the entertainment value of the lottery game.

### BRIEF DESCRIPTION OF THE DRAWINGS

FIG. 1 is an oblique view illustrating the configuration of a lottery game device according to one or more embodiments;

FIG. 2 is a diagram illustrating the configuration of the first lottery machine of the lottery game device according to one or more embodiments;

FIG. 3 is a diagram illustrating the configuration of the lottery table of the lottery game device according to one or more embodiments;

FIG. 4 is a diagram illustrating the configuration of a ball used in the lottery game device according to one or more embodiments;

FIG. 5 is a diagram illustrating a partial configuration of the first lottery machine of the lottery game device according to one or more embodiments;

FIG. 6 is an oblique view illustrating the configuration of the identification unit of the first lottery machine of the lottery game device according to one or more embodiments;

FIG. 7 is a diagram illustrating the configuration of the selection unit of the first lottery machine of the lottery game device according to one or more embodiments;

FIG. 8 is a diagram illustrating the configuration of the conveyance path and its surroundings of the first lottery machine of the lottery game device according to one or more embodiments;

FIG. 9 is a diagram illustrating the configuration of the ball conveyance unit of the first lottery machine of the lottery game device according to one or more embodiments;

FIG. 10 is an oblique view illustrating the configuration of the feed unit of the first lottery machine of the lottery game device according to one or more embodiments;

FIG. 11 is an oblique view illustrating the configuration of the feed rail of the feed unit of the first lottery machine of the lottery game device according to one or more embodiments;

FIG. 12 is an oblique view illustrating the configuration of the ball holder of the feed unit of the first lottery machine of the lottery game device according to one or more embodiments;

FIG. 13 is an oblique view illustrating the configuration of the sub-conveyance path of the feed unit of the first lottery machine of the lottery game device according to one or more embodiments;

FIG. 14 is an oblique view illustrating the configuration of the feed unit of the first lottery machine of the lottery game device according to one or more embodiments;

FIG. 15 is an oblique view illustrating the configuration of the sub-conveyance path of the feed unit of the first lottery machine of the lottery game device according to one or more embodiments;

FIG. 16 is an oblique view illustrating changes in ball conveyance by the feed unit of the first lottery machine of the lottery game device according to one or more embodiments;

FIG. 17 is an oblique view illustrating the state in which a ball is conveyed to the sub-conveyance path by the feed unit of the first lottery machine of the lottery game device according to one or more embodiments;

FIG. 18 is an oblique view illustrating the state in which a ball is fed by the feed unit of the first lottery machine of the lottery game device according to one or more embodiments;

FIG. 19 is an oblique view illustrating the configuration of the second lottery machine of the lottery game device according to one or more embodiments;

FIG. 20 is a sectional view illustrating the configuration of the second lottery machine of the lottery game device according to one or more embodiments;

FIG. 21 is an oblique view illustrating the state in which a ball is conveyed to the rotary disk of the second lottery machine of the lottery game device according to one or more embodiments;

FIG. 22 is an oblique view illustrating the state immediately before the ball of the lottery game device according to one or more embodiments drops into the lottery hole of the second lottery machine;

FIG. 23 is a diagram illustrating the functional configuration of a control unit of the lottery game device according to one or more embodiments;

FIG. 24 is a flowchart illustrating the processing of the first lottery game performed by the control unit of the lottery game device according to one or more embodiments;

FIG. 25 is a flowchart illustrating the details of Step S01 in FIG. 24;

FIG. 26 is a flowchart illustrating the game cancellation and collection processing performed by the control unit of the lottery game device according to one or more embodiments; and

FIG. 27 is a flowchart illustrating the processing of the second lottery game, performed by the control unit of the lottery game device according to one or more embodiments.

### DETAILED DESCRIPTION

Embodiments will now be described with reference to the drawings. The positional relationships, such as up, down, left, and right in the drawings, are based on the positional relationships shown in the drawings, unless otherwise specified. Also, the dimensional ratios in the drawings are not limited to those that are depicted. Furthermore, the following embodiments are given for the sake of describing the present invention, and the present invention is not limited to these embodiments. Moreover, the present invention can be modified in various ways without departing from the gist thereof.

### Lottery Game Device Overview

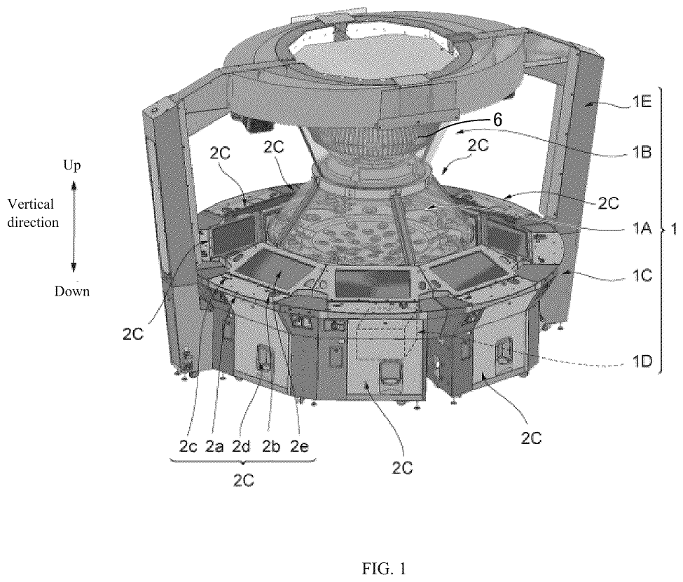

First, an overview of the lottery game device 1 according to one or more embodiments will be described with reference to FIG. 1.

The lottery game device 1 according to one or more embodiments is an example of a lottery game device designed for conducting a lottery game using balls. The lottery game device 1 is a game device that allows up to eight players to play simultaneously. As shown in FIG. 1, the lottery game device 1 includes a first lottery machine 1A located below, a second lottery machine 1B located above the first lottery machine 1A, an operation unit 1C disposed around the first lottery machine 1A, a control unit 1D disposed inside the lottery game device 1, and a housing 1E disposed around the first lottery machine 1A and the second lottery machine 1B. Here, the first lottery machine 1A and the second lottery machine 1B are examples of a lottery device provided to the lottery game device 1. Also, the lottery game device 1 may include either one of the first lottery machine 1A or the second lottery machine 1B.

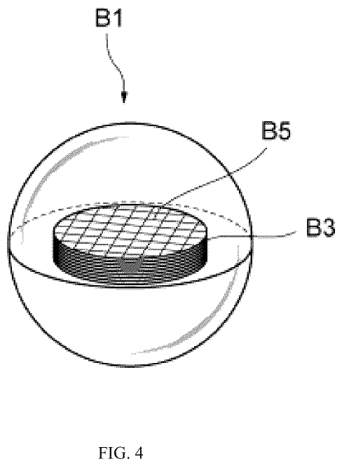

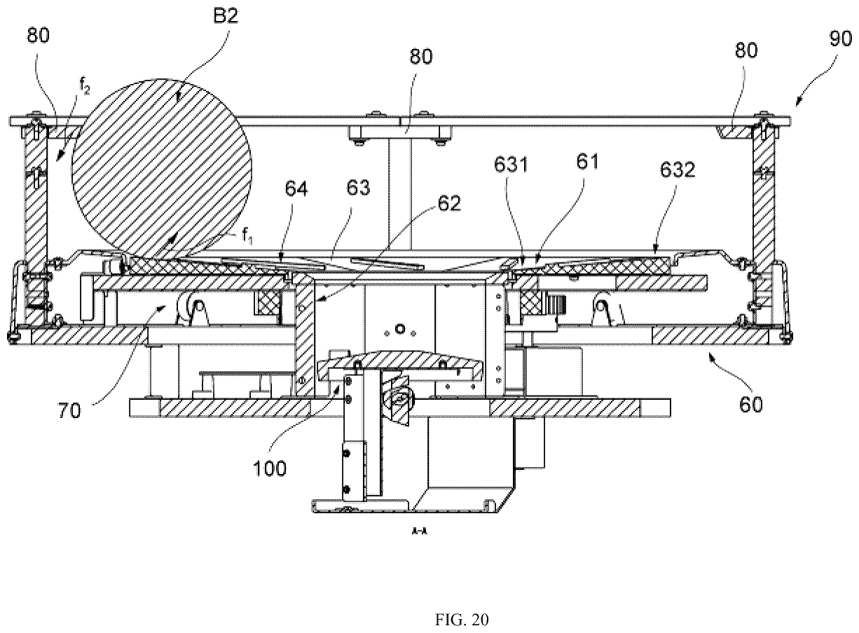

The first lottery machine 1A is a component used to play a first lottery game. The second lottery machine 1B is a component used to play a second lottery game that is different from the first lottery game. Here, the first lottery game may be, for example, a bingo lottery game played using a plurality of small balls B1 (see FIG. 4). The balls B1 include translucent resin balls in three colors: red, green, and yellow. The balls B1 may include balls of four colors, depending on the details of the first lottery game. The second lottery game may be, for example, a jumbo lottery game played using one large ball B2 (see FIG. 20). In the following description, when there is no need to distinguish between the first lottery game and the second lottery game, the two may be collectively referred to as a “lottery game.”

The operation unit 1C has eight satellites 2C. Each satellite 2C is configured to allow the player to perform operations related to the lottery game. As shown in FIG. 1, each satellite 2C includes: an operations table 2a; an operations button 2b for accepting the input of operations by the player related to the lottery game; a media acceptance unit 2c for accepting game media through operations by the player; a media payout unit 2d for paying out to the player real game media or virtual game media corresponding to the lottery results of the first lottery machine 1A and/or the second lottery machine 1B; and a display unit (or display) 2e that displays information related to the lottery game and the player's operations. The operation unit 1C may comprise a central processing unit (CPU) that controls the respective components or may be controlled by the control unit 1D.

Here, the game media may be either physical game media or electronic game media. When physical game media are used, the media acceptance unit 2c may be a physical unit such as a coin slot, and the media payout unit 2d may be a physical unit such as discharge port. When electronic game media are used, the media acceptance unit 2c and the media payout unit 2d are displayed on the display unit 2e. Physical game media may be, for example, a coin-shaped physical object made of a material such as metal or plastic. An electronic medal may be, for example, an object that has data recorded on it or that is linked to electronic media.

The control unit 1D may comprise a central processing unit (CPU), a read only memory (ROM), and a random access memory (RAM), for example, and that controls the operations of the first lottery machine 1A, the second lottery machine 1B, and the operation unit 1C. The housing 1E is a component used for housing the first lottery machine 1A, the second lottery machine 1B, speaker(s) 1G for outputting game sounds such as background music, an illumination unit (or electric decoration member) 1F that may comprise light emitter(s), display posters, and the like.

The flow of the lottery game will now be described. The player at each satellite 2C inserts game media into the media acceptance unit 2c while looking at the lottery display of bingo or the like displayed on the display unit 2e provided to the satellite 2C. The inserted medals are stored in the control unit 1D as information for each player such as the number of medals they have, etc. Since the lottery for the bingo game is performed at specific time intervals, the first lottery game and/or the second lottery game is performed after a predetermined time has elapsed. After this, the control unit 1D determines the lottery result and displays that lottery result on the display unit 2e of each satellite 2C. At this point, if bingo has been achieved, the control unit 1D controls the media payout unit 2d to pay out game media according to the number (amount) of game media inserted, based on the lottery result.

### Main Components of Lottery Game Device 1

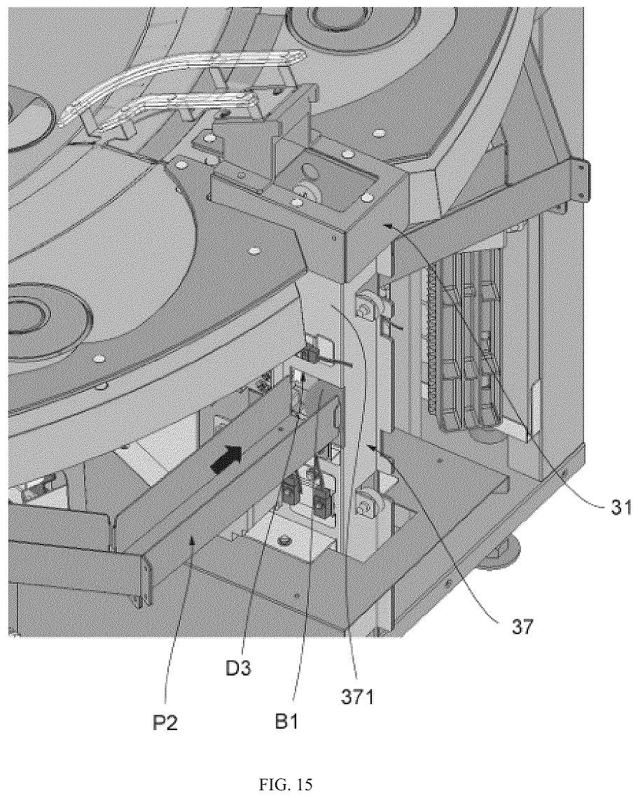

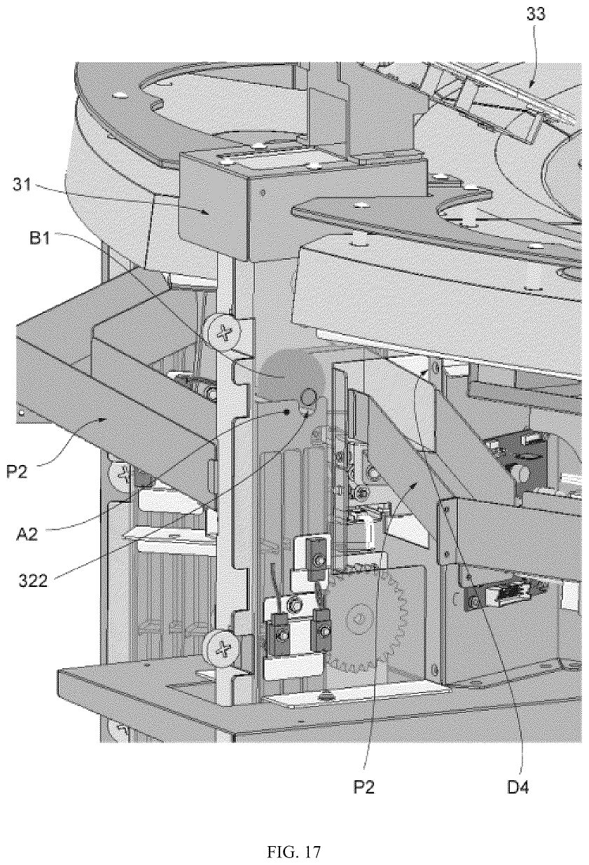

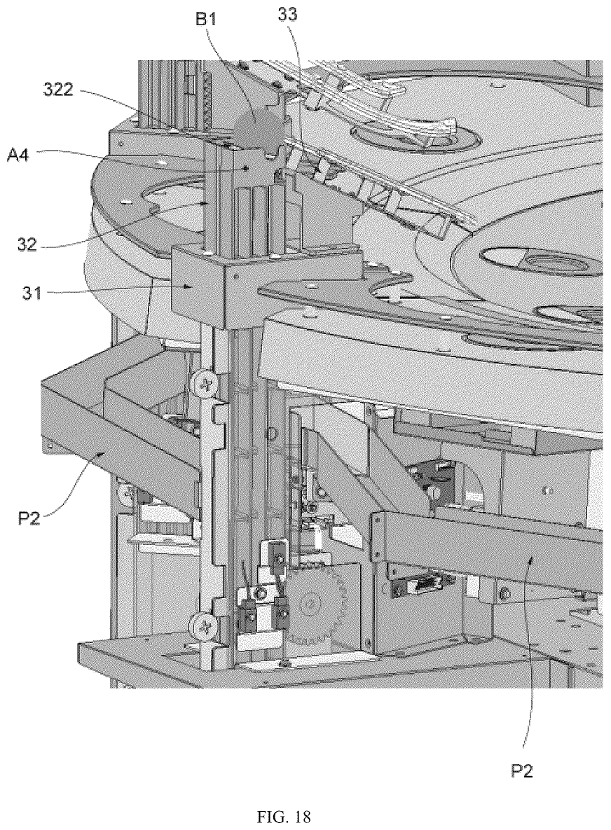

Next, the main components of the lottery game device 1, namely, the first lottery machine 1A, the second lottery machine 1B, and the control unit 1D, will be described in detail, with reference to FIGS. 1 to 27.

### First Lottery Machine 1A

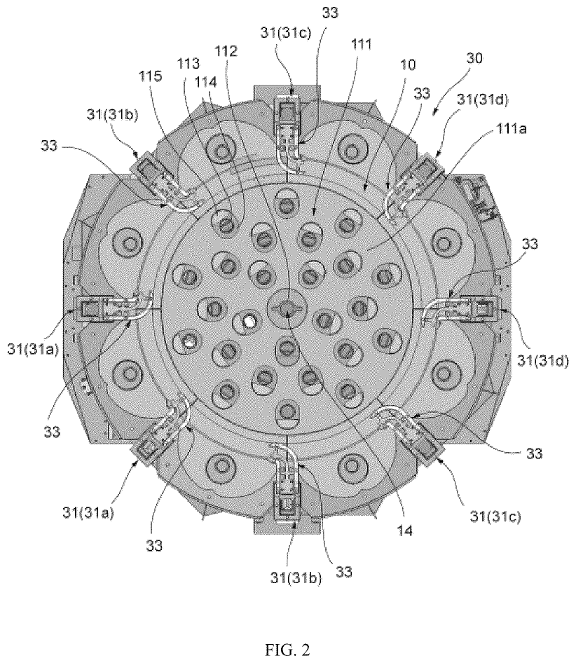

As shown in FIGS. 2, 3, and 8, the first lottery machine 1A includes the lottery table 10 used for a bingo lottery, a ball identification and storage unit 20 that identifies and stores balls B1 by color, ball feed units 30 for feeding the lottery balls B1 into the lottery table 10, a ball conveyance unit 40 that conveys the balls B1 stored in the ball identification and storage unit 20 to the ball feed unit 30, and a ball collection unit 50 for collecting the balls B1 on the lottery table 10 and in each ball feed unit 30. The first lottery machine 1A may comprise a central processing unit (CPU) that controls the respective components or may be controlled by the control unit 1D.

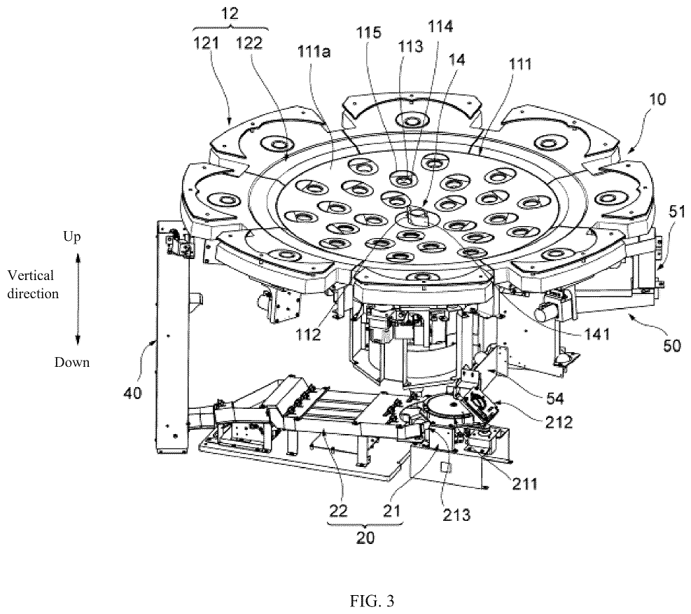

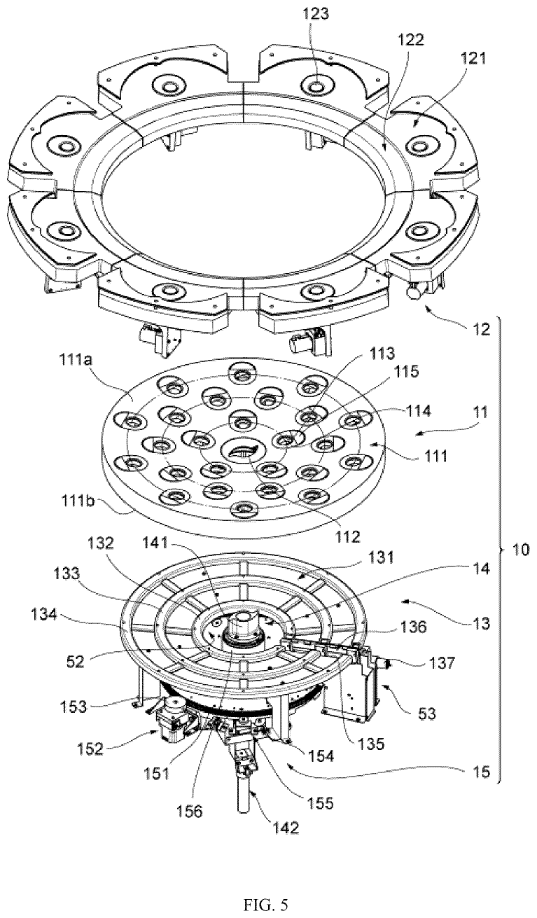

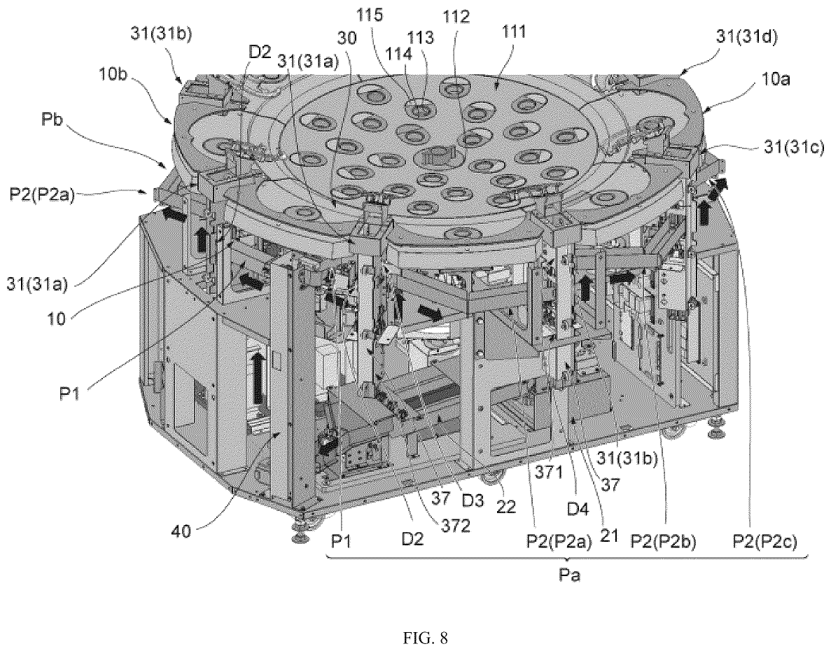

The ball feed units 30 are disposed around the lottery table 10. The ball identification and storage unit 20 and the ball collection unit 50 are disposed below the lottery table 10, as shown in FIG. 3. As shown in FIG. 5, the ball conveyance unit 40 and the ball collection unit 50 are each connected to the ball identification and storage unit 20. As shown in FIG. 8, the ball conveyance unit 40 is configured to convey balls B1 directly or indirectly to the ball feed unit 30 via a conveyance path P.

Thus, when the first lottery game begins, the balls B1 stored in the ball identification and storage unit 20 are conveyed by the ball conveyance unit 40 to the ball feed unit 30, and then fed into the lottery table 10 by the ball feed unit 30 so that the first lottery game can be played. After the first lottery game is over, the balls B1 on the lottery table 10 are collected by the ball collection unit 50 and conveyed back to the ball identification and storage unit 20 for storage therein.

Also, the different colored balls B1 used in the lottery game all have the same configuration. As shown in FIG. 4, an IC tag B3 and reflective stickers B5 disposed on both sides of the IC tag B3 are built into each ball B1. The IC tag B3 is a small recording medium. The IC tag B3 stores information that identifies the ball, such as information that identifies the color of the ball. The IC tag B3 performs wireless non-contact communication with an antenna 212 provided to the identification unit 21 (discussed below), utilizing the electromagnetic induction that occurs between the IC tag B3 and the antenna 212.

### Lottery Table 10

Next, the lottery table 10 will be described in detail with reference to FIGS. 2 to 5. As shown in FIG. 5, the lottery table 10 includes a rotating unit 11, a surrounding unit 12 attached around the rotating unit 11, a support unit 13 disposed on the lower surface of the rotating unit 11 and rotatably supporting the rotating unit 11, a pinwheel unit 14 disposed to be rotatable relative to the rotating unit 11 and movable in the vertical direction, and a drive unit 15 that rotates the rotating unit 11.

As shown in FIG. 5, the rotating unit 11 has a rotary disk 111, a center hole 112 formed in the center of the rotary disk 111, a plurality of holes 113 (e.g., 25) disposed on three concentric circles centered on the center hole 112, light-emitting units (or light emitters) 114 disposed near each hole 113, display units 115 disposed near each hole 113, and a pair of infrared sensors (not shown) disposed underneath each hole 113.

The rotary disk 111, together with the surrounding unit 12, constitutes the upper surface portion of the lottery table 10. The rotary disk 111 has a dish shape, i.e., a flattened cone shape. The rotary disk 111 has an upper surface 111a and a lower surface 111b on either side in the thickness direction. The upper surface 111a forms a conical surface.

The center hole 112 is a component that allows the passage of a pinwheel main body 141 of the pinwheel unit 14 (discussed below). When the pinwheel main body 141 is positioned at the same height as the center hole 112 or higher than the center hole 112, the balls B1 cannot go into the center hole 112. On the other hand, when the pinwheel main body 141 is positioned below the center hole 112, the balls B1 can go into the center hole 112 and enter the central collection unit 52 of the ball collection unit 50 (discussed below).

The holes 113 are configured so that a lottery is conducted based on the numerical value corresponding to the holes 113 into which the balls B1 have dropped. In the example shown in FIG. 5, the number of holes 113 is 25, but the number of holes 113 is not limited to this. As shown in FIG. 5, the 25 holes 113 are disposed at equal intervals on three concentric circles. The light-emitting units 114 are configured to guide the player by emitting light in the same color as the balls B1 that are supposed to enter the hole of that specific color, thus improving the visibility of this guidance. The light-emitting units 114 each include four LEDs capable of emitting multiple colors such as red, blue, green, and yellow. During the first lottery game, each of the 25 light-emitting units 114 can randomly emit full-color light by combining colors such as red, blue, green, and yellow, based on control by the control unit 1D.

The display units 115 may comprise displays and/or touch panels and are configured to display the lottery details (such as numbers or other images) corresponding to the holes 113 into which the balls B1 have dropped. During the first lottery game, each of the 25 display units 115 can randomly display a number from “1” to “25,” for example, based on control by the control unit 1D.

The pair of infrared sensors are configured to detect whether or not a ball B1 has entered a hole 113. The pair of infrared sensors are provided so that the infrared rays they emit intersect with each other at a right angle, and the intersection of the infrared rays is offset from the center of each hole 113.

The surrounding unit 12, together with the rotary disk 111, constitutes the upper surface portion of the lottery table 10. As shown in FIG. 5, the surrounding unit 12 has an outer circumferential unit 121 and a circumferential lane 122 disposed on the inner peripheral side of the attachment unit 121.

The outer circumferential unit 121 has light-emitting units 123 corresponding to each of the eight satellites 2C. The light-emitting units 123 are able to indicate information about winning a lottery by emitting light, for example. The circumferential lane 122 is evenly connected to the upper surface 111a of the rotary disk 111 and is configured to guide the rolling of the ball B1 fed by the ball feed unit 30 together with the upper surface 111a.

Here, the surface formed by the circumferential lane 122 and the upper surface 111a of the rotary disk 111 allows the ball B1, which is fed in the tangential direction of the circumferential lane 122 by the feed rail 33 (see FIG. 2) of the ball feed unit 30 (discussed below), to roll in an arc over the circumferential lane 122 while gradually rolling onto the upper surface 111a of the rotary disk 111 to the inside, and then to rotate in an arc on the upper surface 111a while gradually approaching the center of the upper surface 111a.

As shown in FIG. 5, the support unit 13 is a component for rotatably supporting the rotary disk 111. The support unit 13 is fixed to the housing 1E. The support unit 13 has an upper surface 131 that supports the rotary disk 111, ball support rings 132, 133, and 134 formed on the upper surface 131, a collection hole 135 that passes through the rotary disk 111 in its thickness direction, a flap 136 provided to the collection hole 135 to allow the collection hole 135 to be opened and closed, and a flap drive unit (or flap driver) 137 that may comprise a motor and that drives a change in the orientation of the flap 136.

The ball support rings 132, 133, and 134 are configured to hold the balls B1 in holes 113 and to cause the balls B1 to roll on the three ball support rings 132, 133, and 134 when the rotary disk 111 rotates. As shown in FIG. 5, when the support unit 13 and the rotary disk 111 are attached to be stacked one on top of the other, the ball support rings 132, 133, and 134 are formed at positions on the upper surface 131 corresponding to the three concentric circles in which the 25 holes 113 of the rotary disk 111 are located.

The collection hole 135, together with the flap 136, is a component that is used to drop the balls B1 in the holes 113 of the rotary disk 111 into the collection groove 53 of the ball collection unit 50 (discussed below). The collection hole 135 has a rectangular shape.

The flap 136 has a shape similar to that of the collection hole 135 to be able to cover the collection hole 135. A portion of the ball support rings 132, 133, and 134 is formed on the upper surface of the flap 136. The flap 136 is provided to allow the collection hole 135 to be opened and closed by rotating relative to the collection hole 135 by the driving action of the flap drive unit 137.

When the flap 136 closes the collection hole 135, a ball B1 in a hole 113 of the rotary disk 111 will not drop into the collection groove 53 through the collection hole 135 as the rotary disk 111 rotates and passes the collection hole 135. In this case, the ball B1 rolls on a portion of the ball support rings 132, 133, 134 on the flap 136. On the other hand, when the flap 136 opens the collection hole 135, as the rotary disk 111 rotates and passes the collection hole 135, the ball B1 in the hole 113 of the rotary disk 111 drops into the collection groove 53 through the collection hole 135 and is thus collected.

The pinwheel unit 14 is configured so that when a ball B1 rotates on the upper surface of the rotary disk 111 and approaches the center hole 112, the ball B1 bounces on the peripheral edge portion of the rotary disk 111 or the circumferential lane 122, thereby causing the ball B1 to enter a hole 113. As shown in FIG. 5, the pinwheel unit 14 has a pinwheel main body 141 and a pinwheel drive unit (or pinwheel driver) 142 that may comprise a motor and that drives the movement of the pinwheel main body 141.

As shown in FIG. 5, the pinwheel main body 141 is disposed within a central collection tube 52 of the ball collection unit 50 (discussed below), which is coupled to the center hole 112 of the rotary disk 111. The pinwheel drive unit 142 drives the pinwheel main body 141 to move up and down and rotate.

More specifically, the pinwheel drive unit 142 can move the pinwheel main body 141 within a range from a position above the upper surface 111a to a position below the upper surface 111a. Also, when the pinwheel main body 141 is positioned above the upper surface 111a, the pinwheel drive unit 142 drives the rotation of the pinwheel main body 141.

Consequently, the pinwheel main body 141 can deflect a ball B1 that comes into contact with the pinwheel main body 141. Also, when the pinwheel main body 141 is positioned below the upper surface 111a, the center hole 112 opens. In this case, the ball B1 falls through the center hole 112 and enters the central collection tube 52, where it is collected.

The drive unit 15 is an example of a component that drives the rotation of the rotary disk 111. As shown in FIG. 5, the drive unit 15 has a rotary transmission disk 151 for transmitting rotation to the rotary disk 111, a motor 152, a drive roller 153 for transmitting the output of the motor 152 to the rotary transmission disk 151, a plurality of rollers 154 for rotatably supporting the rotary transmission disk 151, and a plurality of rollers 155 for pressing the rotary transmission disk 151 from its outer circumferential surface to set the position of the rotary transmission disk 151.

A mounting post 156 for mounting the rotary disk 111 is disposed in the center of the rotary transmission disk 151. The rotary disk 111 is fixed to the mounting post 156, which allows the rotary disk 111 to rotate along with the rotation of the rotary transmission disk 151.

### Ball Identification and Storage Unit 20

Next, the configuration of the ball identification and storage unit 20 will be described with reference to FIGS. 3, 6, and 7. The ball identification and storage unit 20 is an example of a component that stores the balls B1 collected by the ball collection unit 50 by color. As shown in FIG. 3, the ball identification and storage unit 20 has an identification unit 21 that identifies the color of the balls B1 and sorts by color, and a selection unit 22 that stores, by color, the balls B1 sorted by the identification unit 21 and sends out balls B1 of the color and number specified by the control unit 1D to the ball conveyance unit 40.

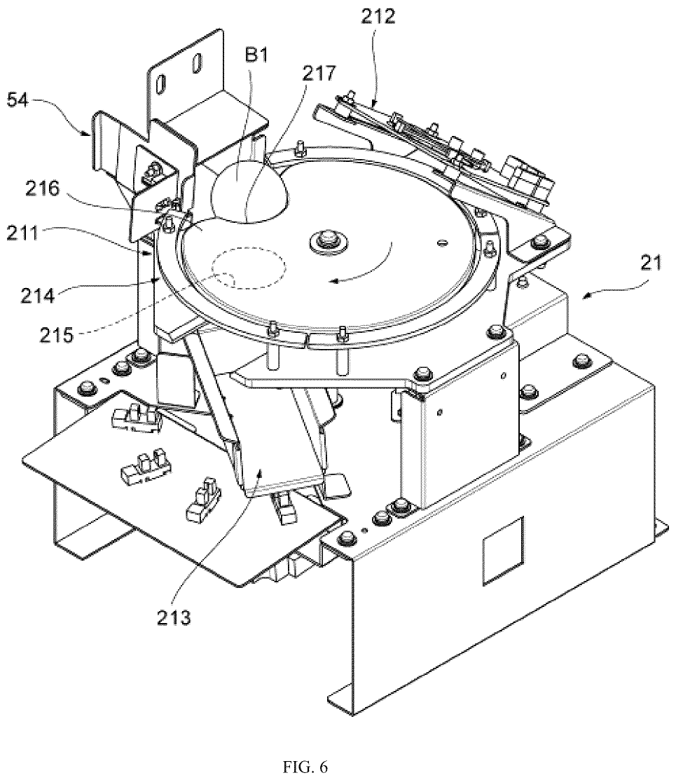

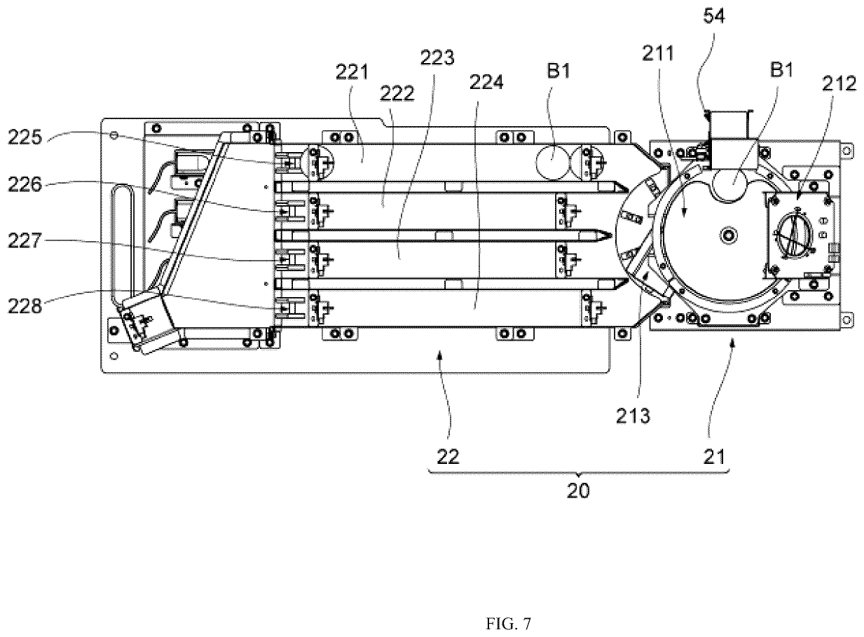

As shown in FIGS. 6 and 7, the identification unit 21 has a conveyance unit 211 that conveys one by one the balls B1 conveyed via a conveyance and collection path 54 of the ball collecting unit 50 (discussed below), an antenna 212 that identifies the color of the balls B1 conveyed by the conveyance unit 211, and a sorting unit (or sorting path) 213 that sorts the balls B1 whose color has been identified by the antenna 212 to a storage unit of the selection unit 22 corresponding to that color.

As shown in FIG. 6, the conveyance unit 211 has a base unit 214, a rotary conveyance disk 216 rotatably provided to the base unit 214, and a drive unit or driver (not shown) that drives the rotation of the rotary conveyance disk 216.

The base unit 214 is a component that rotatably supports the rotary conveyance disk 216. A drop hole 215 for dropping the balls B1 into the sorting unit 213 is disposed at a position of the base unit 214 corresponding to the sorting unit 213, that is, a position directly above sorting unit 213.

The rotary conveyance disk 216 comprises a holding unit 217 for holding the balls B1. The holding unit 217 is a recess formed in the rotary conveyance disk 216. When the conveyance unit 211 is on standby, the rotary conveyance disk 216 is disposed so that the holding unit 21 is facing the exit of the conveyance and collection path 54. In this way, when a ball B1 is conveyed from the conveyance and collection path 54 to the conveyance unit 211, that ball B1 is held by the holding unit 217 and then rotates in the direction shown in FIG. 6 on rotary conveyance disk 216, thereby being conveyed to the antenna 212, and then to the drop hole 215.

The antenna 212 constitutes an RFID (Radio Frequency Identification) system for communicating with the IC tag B3 built into the balls B1. More specifically, when a ball B1 is conveyed under the antenna 212, the antenna 212 transmits an activation signal to the IC tag B3 of the ball B1. The IC tag B3 of the ball B1 receives the activation signal, generates an electromotive force due to the energy of the activation signal, activates an internal control circuit, and commences communication via the antenna 212. The antenna 212 then receives a color identification signal, which is information identifying the color of the ball B1 transmitted by the IC tag B3 of the ball B1, and transmits this to the control unit 1D. The control unit 1D can detect the color of the ball B1 by decoding this color identification signal.

The sorting unit 213 is a component that, based on a control signal from the control unit 1D, sorts by color the balls B1 that have dropped due to rotation from the conveyance unit 211 into the storage units of the selection unit 22 that correspond to the colors of the balls B1.

As shown in FIG. 7, the selection unit 22 has storage units 221, 222, 223, and 224 that store the balls B1 sorted by the sorting unit 213 by color, solenoids 225, 226, 227, and 228 that can convey one by one the balls B1 stored in the storage units 221, 222, 223, and 224 to the ball conveyance unit 40, and drive units that drive the solenoids 225, 226, 227, and 228.

Here, in the first lottery game, more green balls are used than yellow balls and red balls. Accordingly, the selection unit 22 comprises two storage units for storing green balls. That is, the storage units 221, 222, 223, and 224 are respectively used to store green balls, green balls, yellow ball, and red balls.

During a lottery game, the solenoids 225, 226, 227, and 228 respectively convey one ball B1 in each of the corresponding storage units 221, 222, 223, and 224 to the ball conveyance unit 40 based on the color and number of balls B1 specified by the conveyance signal from the control unit 1D.

### Ball Conveyance Unit 40

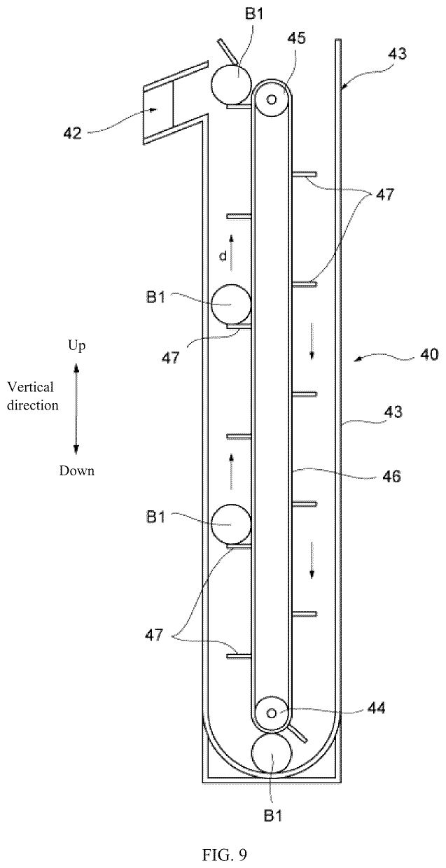

As shown in FIG. 9, the ball conveyance unit 40 has a conveyance lifter 41 for conveying a ball B1, a sorting unit (or sorting path) 42 that allocates the conveyance direction of the ball B1 and is disposed at the location of connection between the conveyance lifter 41 and conveyance path P, and a housing 43 for attaching and housing the conveyance lifter 41 and the sorting unit 42.

The conveyance lifter 41 is an example of a component capable of successively conveying a plurality of balls B1 in a single operation (that is, one complete rotation of an endless belt 46 (discussed below)). As shown in FIG. 9, the conveyance lifter 41 has a pair of pulleys 44 and 45, an endless belt 46 stretched between the pair of pulleys 44 and 45, a plurality of ball holders 47 that are spaced equally apart on the surface of the endless belt 46 and on which balls B1 are placed, and a drive unit (or driver) 48 that may comprise a motor and that drives the rotation of the pulley 44.

During a game, the pulley 44 is rotated by the drive force applied to the pulley 44 by the drive unit 48, and the endless belt 46 and the ball holders 47 rotate in the direction d shown in FIG. 9. Then, a ball B1 conveyed by the selection unit 22 to below the conveyance lifter 41 is caught by a rotating ball holder 47 and placed on the ball holder 47. The ball B1 is then conveyed to the sorting unit 42 above by the rotation of the endless belt 46.

Every time a ball B1 is conveyed by the conveyance lifter 41 based on an allocation signal from the control unit 1D, the sorting unit 42 can allocate the ball B1 to one of the conveyance paths P (discussed below), namely, either a conveyance path Pa on the first peripheral edge portion 10a side of the lottery table 10 or a conveyance path Pb on the second peripheral edge portion 10b side of the lottery table 10. The detailed configuration of the conveyance path P will be described after describing the configuration of the ball feed unit 30.

### Ball Feed Unit 30

As shown in FIG. 2, the ball feed unit 30 has eight ball feeders 31 spaced apart equally around the periphery of the lottery table 10. The eight ball feeders 31 all have the same structure. Also, as shown in FIG. 2, of the eight ball feeders 31, four ball feeders 31 are spaced apart equally on the first peripheral edge portion 10a of the lottery table 10, and the other four ball feeders 31 are spaced apart equally on the second peripheral edge portion 10b of the lottery table 10. The first peripheral edge portion 10a and the second peripheral edge portion 10b have the same dimensions. Also, the ball conveyance unit 40 is located on one side at the boundary between the first peripheral edge portion 10a and the second peripheral edge portion 10b. Accordingly, the eight ball feeders 31 are disposed on both sides of the ball conveyance unit 40.

The following description will focus on the four ball feeders 31 provided to the first peripheral edge portion 10a of the lottery table 10. Note that, when distinguishing between the four feed units 30, these four feed units 30 will sometimes be referred to as the “ball feeders 31a, 31b, 31c, and 31d.” The ball feeder 31a is an example of a first feed unit, and is disposed to be adjacent to the ball conveyance unit 40. The ball feed unit 30d is an example of a second feed unit, and is disposed to be adjacent to the main collection tube 51 of the ball collection unit 50 (discussed below). The ball feeders 31b and 31c are disposed between the ball feeder 31a and the ball feeder 31d.

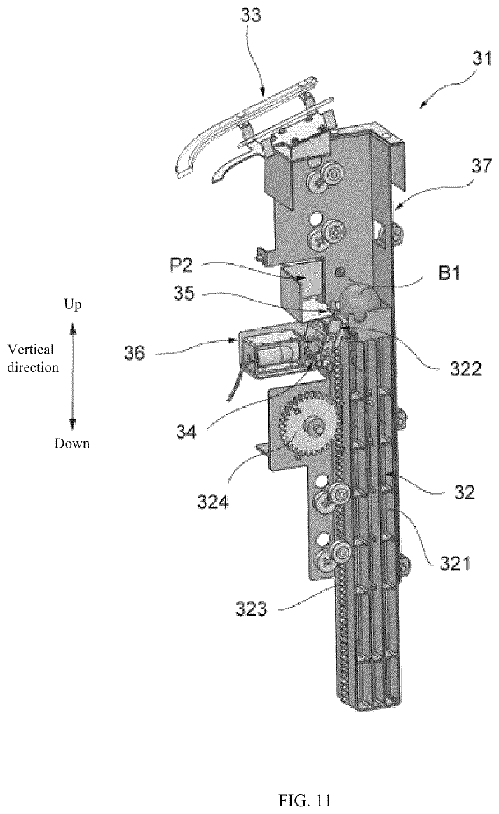

As shown in FIG. 11, the ball feeders 31 each have a sub-conveyance lifter 32 for conveying a ball B1, a feed rail 33 for feeding the ball B1 into the rotary disk 10 in a specific direction, a conveyance change unit 34 for changing the conveyance destination of the ball B1, a ball detector 35 for detecting the presence of a ball B1 in the sub-conveyance unit 31, a drive unit (or driver) 36 that may comprise a motor and that drives the operation of the sub-conveyance unit 31 and the conveyance change unit 34, and a housing 37 in which the sub-conveyance lifter 32 and other components are attached and housed.

The sub-conveyance lifter 32 is an example of a component that can convey one ball B1 for one operation (that is, one up-down movement of the lifter main body 321 (discussed below)). The sub-conveyance lifter 32 is configured to be able to convey the ball B1 to another ball feed unit 30 and to convey the ball B1 to the feed rail 33.

Also, the sub-conveyance lifter 32 has a simpler configuration than the conveyance lifter 41 of the ball conveyance unit 40. More specifically, as shown in FIG. 11, the sub-conveyance lifter 32 has a lifter main body 321, a ball holder 322 that holds a ball B1 and is disposed at the upper end of the lifter main body 321, a pinion 323 provided to the lifter main body 321, and a gear 324 that is attached to the housing 37 to mesh with the pinion 323.

During a game, the drive unit 36 is actuated to rotate the gear 324, thereby moving the pinion 323 up or down. As the pinion 323 moves, the lifter main body 321 and the ball holder 322 also move up or down. As a result, the ball B1 held by the ball holder 322 can also move up or down.

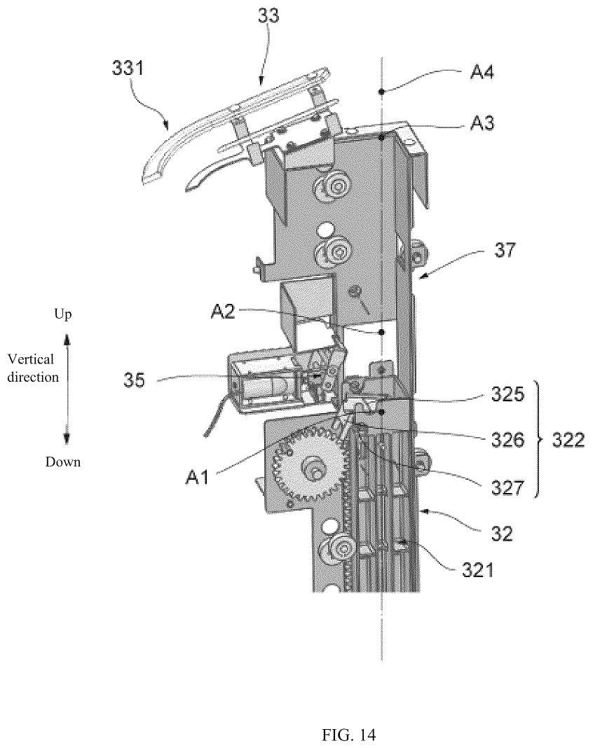

Also, the drive unit 36 can stop the rotation of the gear 324 in response to a control signal from the control unit 1D. Consequently, the ball holder 322 attached to the lifter main body 321 is able to stop at the standby position A1, the conveyance change position A2, the feed standby position A3, and the feed position A4, while moving upward in the vertical direction, as shown in FIG. 14. The standby position A1 is the position where the ball feeder 31 receives a ball B1 conveyed by the ball conveyance unit 40. The conveyance change position A2 is the position where a ball B1 in one ball feeder 31 can be advanced toward another ball feeder 31. The feed position A4 is the entrance position of the feed rail 33 of the ball feeder 31. The feed standby position A3 is a position directly below the feed position A4.

Here, the conveyance path P will be described in conjunction with descriptions of the standby position A1, the conveyance change position A2, the feed standby position A3, and the feed position A4. The conveyance path P has a conveyance path Pa on the first peripheral edge portion 10a side of the lottery table 10 and a conveyance path Pb on the second peripheral edge portion 10b side of the lottery table 10. Since the conveyance paths Pa and Pb have the same configuration, the description here will focus on the conveyance path Pa.

As shown in FIG. 8, the conveyance path Pa has a main conveyance path P1 that links the ball conveyance unit 40 and the ball feed unit 30a, a sub-conveyance path P2a that links the ball feed unit 30a and the ball feed unit 30b, a sub-conveyance path P2b that links the ball feed unit 30b and the ball feed unit 30c, and a sub-conveyance path P2c that links the ball feed unit 30c and the ball feed unit 30d. The sub-conveyance path P2a, the sub-conveyance path P2b, and the sub-conveyance path P2c all have the same configuration. The following description will focus on the sub-conveyance path P2a. Also, when the sub-conveyance paths P2a, P2b, and P2c are not to be differentiated from one another, each of the three may be referred to as the “sub-conveyance path P2.”

The main conveyance path P1 is disposed at an incline so that the ball B1 conveyed on the main conveyance path P1 advances along the main conveyance path P1 under its own weight. More specifically, as shown in FIG. 8, the main conveyance path P1 has a main path inlet D1 that is connected to the sorting unit 42 of the ball conveyance unit 40, and a main path outlet D2 that is connected to the ball feeder 31a. As shown in FIG. 8, the main path outlet D2 is an opening formed in a side surface 371 of the housing 37 of the ball feeder 31a. The main path outlet D2 is disposed at the same height as the standby position A1. Thus, as shown in FIG. 8, the main conveyance path P1 is inclined so that the main path inlet D1 is located higher than the main path outlet D2.

The sub-conveyance path P2 is disposed at an incline so that a ball B1 conveyed to the sub-conveyance path P2 advances along the sub-conveyance path P2 under its own weight. More specifically, as shown in FIG. 8, the sub-conveyance path P2 has a sub-path inlet D3 that is connected to the ball feeder 31a, and a sub-path outlet D4 that is connected to the ball feeder 31b. As shown in FIG. 8, the sub-path inlet D3 is an opening formed in a side surface 372 of the housing 37 of the ball feeder 31a. The sub-path inlet D3 is disposed at the same height as the conveyance change position A2. As shown in FIG. 8, the sub-path outlet D4 is an opening formed in a side surface 371 of the housing 37 of the ball feeder 31b. The sub-path outlet D4 is disposed at the same height as the standby position A1. Thus, as shown in FIG. 8, the sub-conveyance path P2 is inclined so that the sub-path inlet D3 is located higher than the sub-path outlet D4.

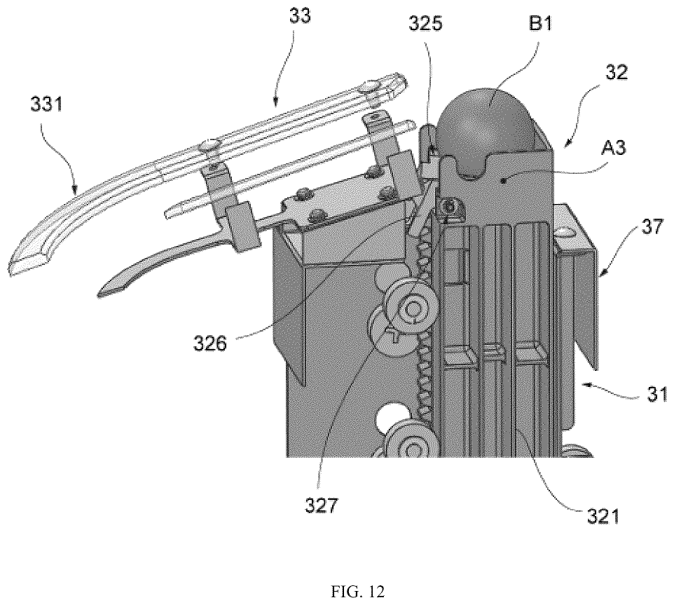

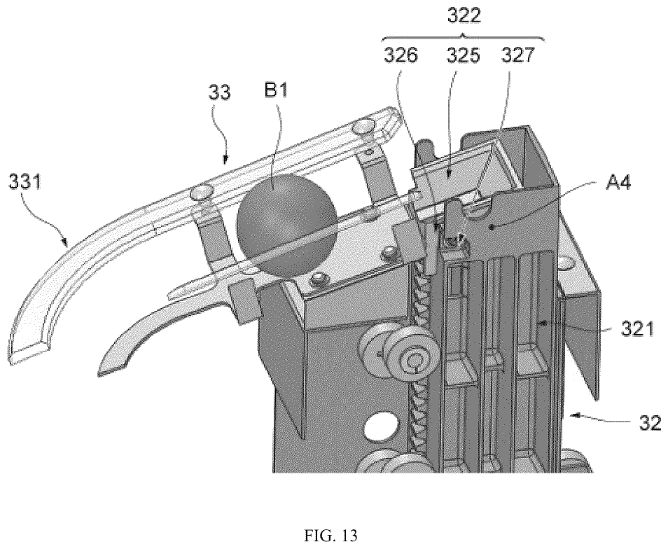

As shown in FIGS. 12 and 13, the ball holder 322 has a holder unit 325, a pressing plate 326 attached to intersect with the holder unit 325, and a rotation shaft 327 attached to the lower surface of the holder unit 325. The ball holder 322 is rotatably disposed at the upper end of the lifter main body 321 via the rotation shaft 327.

When the pressing plate 326 of the ball holder 322 is not subjected to any external force, the holder unit 325 maintains its horizontal state and can hold a ball B1. On the other hand, when the pressing plate 326 of the ball holder 322 is subjected to an external force, the holder unit 325 rotates to be inclined around the rotation shaft 327, and the ball B1 inside the holder unit 325 can be ejected.

Here, the external force exerted on the pressing plate 326 of the ball holder 322 includes the pressing force exerted by the conveyance change unit 34 on the pressing plate 326 when the ball holder 322 is stopped at the conveyance change position A2 and the conveyance change unit 34 is operating, and the pressing force exerted by the feed rail 33 on the pressing plate 326 when the ball holder 322 is stopped at the feed position A4. On the other hand, when the ball holder 322 is stopped at the conveyance change position A2, if the conveyance change unit 34 is not operating, the pressing plate 326 is subjected to no external force and the holder unit 325 maintains its horizontal state.

As shown in FIG. 2, the feed rail 33 is disposed at an incline so that the ball B1 can move along the feed rail 33 under its own weight. Also, the feed rail 33 has a curved distal end portion 331. Guidance by the distal end portion 331 allows the ball B1 to fly out in the tangential direction of the circumference of the circumferential lane 122 of the lottery table 10.

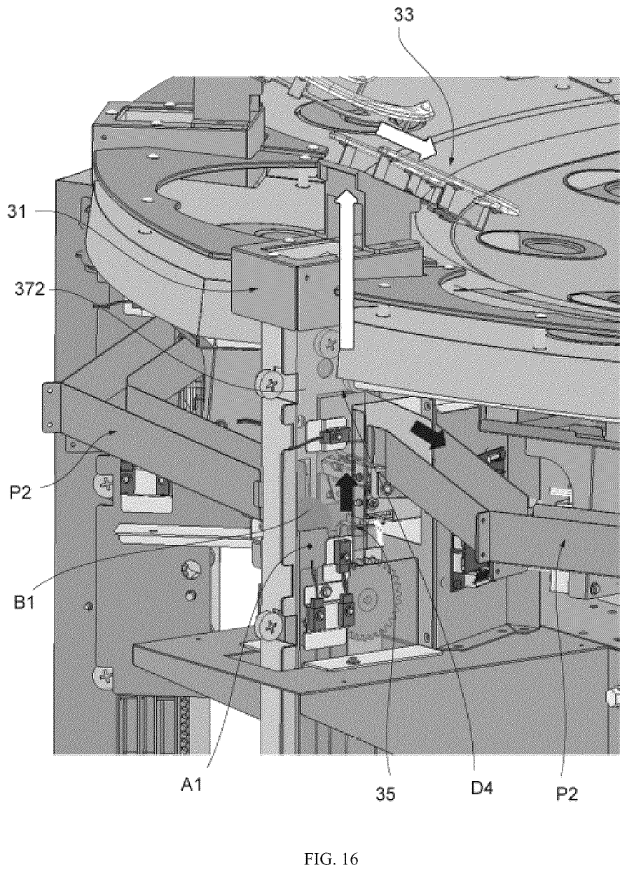

As shown in FIGS. 14 and 16, the detector 35 is disposed on the side surface 373 of the housing 37 of the ball feeder 31 at a position slightly above the standby position A1. Thus, when the ball holder 322 is stopped at the standby position A1, the detector 35 detects whether or not a ball B1 is in the ball holder 322. The detector 35 may also detect the color of the ball B1.

If the detector 35 detects that there is no ball B1 in the ball holder 322, the detector 35 sends that information to the control unit 1D. Then, if no ball B1 is in the ball feeder 31a, the control unit 1D drives the conveyance lifter 41 of the ball conveyance unit 40 to convey a ball B1 to the ball holder 322 of the ball feeder 31a via the main conveyance path P1. On the other hand, if there is no ball B1 in the ball feeder 31b, the control unit 1D first drives the conveyance lifter 41 of the ball conveyance unit 40 to convey a ball B1 via the main conveyance path P1 to the ball holder 322 of the ball feeder 31a, and then drives the sub-conveyance lifter 32 of the ball feeder 31a to convey the ball B1 via the sub-conveyance path P2 to the ball holder 322 of the ball feeder 31b. Also, if there is no ball B1 in ball feeder 31c or the ball feeder 31d, the sub-conveyance lifter 32 of ball feeder 31b or ball feeder 31c may be further driven. In this case, the conveyance of the ball B1 by the sub-conveyance lifter 32 of the ball feeder 31b or the ball feeder 31c is the same as the conveyance of the ball B1 by the sub-conveyance lifter 32 of the ball feeder 31a, and therefore will not be described again here.

### Ball Collection Unit 50

As shown in FIGS. 3, 5, and 10, the ball collection unit 50 has a main collection tube 51 that is connected to the identification unit 21 of the ball identification and storage unit 20, a central collection tube 52 for collecting a ball B1 that has dropped from the center hole 112, and a collection groove 53 for collecting the ball B1 that has dropped from the rotary disk 111 and the central collection tube 52.

As shown in FIG. 5, the central collection tube 52 is provided such that one end is connected to the center hole 112 and the other end is connected to the collection groove 53. As shown in FIG. 5, the collection groove 53 is provided such that its upper end opening 531 is connected to the collection hole 135 of the support unit 13 and the lower end of the central collection tube 52, and its side opening 532 is connected to the main collection tube 51. The main collection tube 51 connects the first ball feeder 31d on the first peripheral edge portion 10a side and the first ball feeder 31d on the second peripheral edge portion 10b side via a collection path R.

The collection path R will now be described. The collection path R has a collection path Ra on the first peripheral edge portion 10a side of the lottery table 10, and a collection path Rb on the second peripheral edge portion 10b side of the lottery table 10. Since the collection paths Ra and Rb have the same configuration, the following description will focus on the collection path Ra.

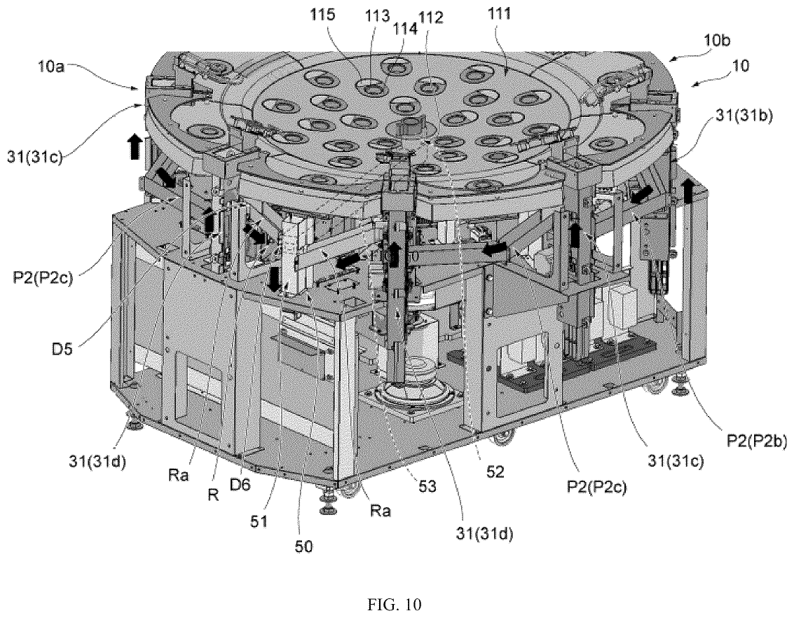

As shown in FIG. 11, the collection path Ra links the ball feed unit 30d and the main collection tube 51. Collection path Ra is disposed at an incline so that a ball B1 conveyed to the sub-conveyance path P2 advances along collection path Ra under its own weight. More specifically, as shown in FIG. 11, collection path Ra has a collection path inlet D5 that is connected to the ball feeder 31d, and a collection path outlet D6 that is connected to the main collection tube 51. As shown in FIG. 10, the collection path inlet D5 is an opening formed in a side surface 372 of the housing 37 of the ball feeder 31d. The collection path inlet D5 is disposed at the same height as the conveyance change position A2. As shown in FIG. 11, the collection path outlet D6 is disposed on a side wall of the main collection tube 51. As shown in FIG. 11, the collection path Ra is inclined so that the collection path inlet D5 is located higher than the collection path outlet D6.

### Second Lottery Machine 1B

As shown in FIG. 1, the second lottery machine 1B includes: a lottery roulette wheel (or lottery roulette) 6 used for a jumbo lottery; a lottery table 60 having a rotary disk 61 and a lottery hole 62 formed in the center of the rotary disk 61; a rotational driver 70 that may comprise a motor, for example, and is configured to rotate a ball B2 placed on the rotary disk 61 in a first direction (or first rotation direction) F1 by rotating the rotary disk 61 (discussed below) of the lottery table 60 in the first direction F1; a rotation imparting member (or rotation imparting elastomer/rubber) 80 configured to apply an external force to the ball B2 rotating in the first direction, thereby rotating the ball B2 in a second direction (or second rotation direction) F2 while maintaining the rotation of the ball B2 in the first direction F1; a guiderail 90 disposed around the rotary disk 61 to limit the range of rotation of the ball B2 in the first direction F1 to within the rotary disk 61 through contact with the ball B2; and a conveyance unit 100 that conveys the ball B2 to the rotary disk 61. The second lottery machine 1B may comprise a central processing unit (CPU) that controls the respective components or may be controlled by the control unit 1D.

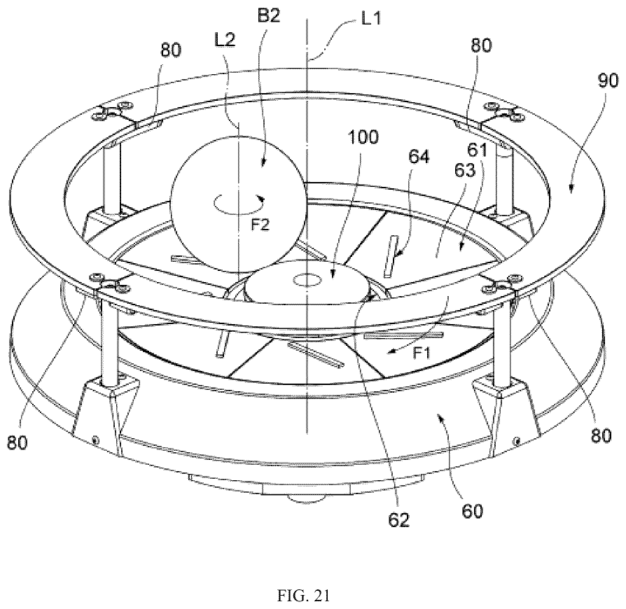

Here, as shown in FIG. 21, the first direction F1 is clockwise, for example, and the second direction F2 is counterclockwise, for example. The second direction F2 may instead be clockwise, and the first direction F1 may be counterclockwise. Also, the rotation of the ball B2 in the first direction F1 and its rotation in the second direction F2 are rotations around different rotational axes. The rotation of the ball B2 in the first direction F1 and in the second direction F2 will be described in detail below.

As shown in FIG. 1, the lottery roulette wheel 6 has a configuration in which a plurality of LEDs are arranged in a cylindrical shape. During a game, the plurality of LEDs of the lottery roulette wheel 6 sequentially emit light in a cyclic manner, and after the ball B2 drops into the lottery hole 62, the cyclic emission of the LEDs stops, and only the LED that was emitting light at the point when the ball B2 dropped into the lottery hole 62 continues to emit light. As a result, the control unit 1D can detect the satellite 2C corresponding to the emitting LED as the winning satellite of the second lottery game.

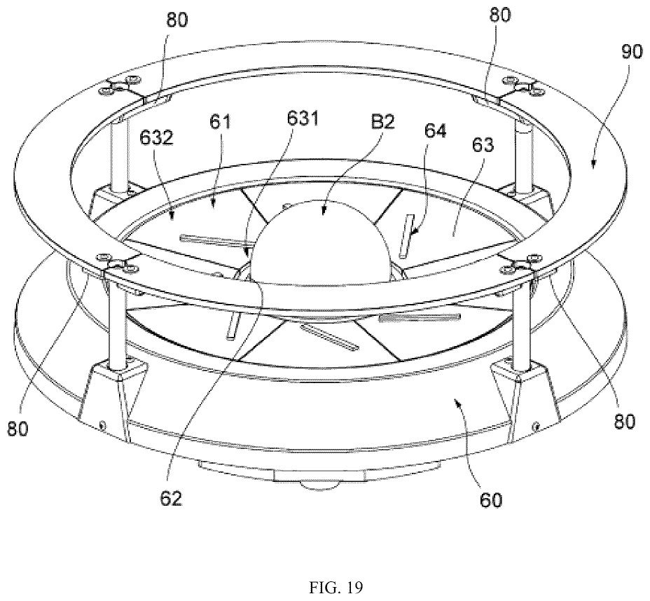

As shown in FIGS. 19 and 20, the rotary disk 61 has a placement surface 63 on which the ball B2 is placed, and a plurality of guide portions 64 disposed on the placement surface 63. The rotary disk 61 is configured to be able to rotate in either the first direction F1 or the second direction F2 by the rotational driver 70.

The lottery hole 62 has an opening 621 on the rotary disk 61 side. The opening 621 can be opened or closed by the conveyance unit 100. When the conveyance unit 100 has closed the opening 621, the ball B2 cannot drop into the lottery hole 62. On the other hand, when the conveyance unit 100 has opened the opening 621, the ball B2 can drop into the lottery hole 62. Also, when the ball B2 drops into the lottery hole 62, the second lottery game using the lottery roulette wheel 6 comes to an end.

As shown in FIG. 20, the placement surface 63 is inclined so that the ball B2 moves, while rotating, from a peripheral edge portion 632 of the placement surface 63 toward the center portion 631 and drops into the lottery hole 62. More specifically, the placement surface 63 has a dish shape. With this placement surface 63, the ball B2 can be caused to roll on the placement surface 63 of the rotary disk 61 while being guided by the guiderail 90 and gradually approach the center portion 631 of the rotary disk 61.

The guide portions 64 are an example of a component that guides the movement of the ball B2 between the peripheral edge portion 632 and the center portion 631 of the placement surface 63. The guide portions 64 protrude from the placement surface 63. The guide portions 64 are configured to guide a first movement M1 of the ball B2 along the guide portions 64 so that the ball B2 moves away from the center portion 631 while maintaining the rotation of the ball B2 in the first direction F1 and the second direction F2 when the rotary disk 61 is rotating in the first direction F1, and to guide a second movement M2 of the ball B2 along the guide portions 64 so that the ball B2 approaches the center portion 631 while maintaining the rotation of the ball B2 in the first direction F1 and the second direction F2 when the rotary disk 61 is rotating in the second direction F2.

The rotational driver 70 is an example of a component that drives the rotary disk 61 to rotate in either the first direction F1 or the second direction F2. The rotational driver 70 can, for example, rotate the rotary disk 61 in the first direction F1 and then rotate the rotary disk 61 in the second direction F2. Also, a ball B2 that has been stopped will roll on the rotary disk 61 due to a frictional force f1 generated between the ball B2 and the placement surface 63 of the rotary disk 61 rotating in the first direction. Then, the ball B2 rotates in the first direction F1 around the first rotation axis L1 due to centrifugal force, with the rotation axis of the rotary disk 61 serving as the first rotation axis L1. In other words, the ball B2 revolves in the first direction F1 around the first rotation axis L1. This revolution of the ball in the first direction F1 will sometimes be referred to herein as the “first rotation T1.”

The rotation imparting member 80 is an example of a component that imparts rotation in the second direction F2 to the ball B2. The rotation imparting member 80 is a component that causes the rotation of the ball B2 in the second direction F2 by using the frictional force generated by contact with the ball B2. The rotation imparting member 80 is a component made of a material such as rubber. As shown in FIGS. 19 to 22, the rotation imparting member 80 is disposed on the guiderail 90. In the example shown in FIGS. 19 to 22, the number of rotation imparting members 80 attached to the guiderail 90 is one but the number is not limited to this. The number of rotation imparting members 80 may be one, or it may be five or more.

During a game, the ball B2 comes into contact with the rotation imparting member 80 due to the first rotation T1. This contact generates a frictional force f2 between the surface of the ball B2 and the rotation imparting member 80. In other words, the rotation imparting member 80 imparts a frictional force f2 in the direction shown in FIG. 19 to the surface of the ball B2. Also, the frictional force f2 is less than the frictional force f1. As a result, while undergoing the first rotation T1, the ball B2 starts to spin in the second direction F2 with the center axis passing through the center of the ball B2 serving as the second rotation axis L2. In other words, the ball B2 spins in the second direction F2 around the second rotation axis L2. The spin of the ball in the second direction F2 will sometimes be referred to herein as the “second rotation T2.”

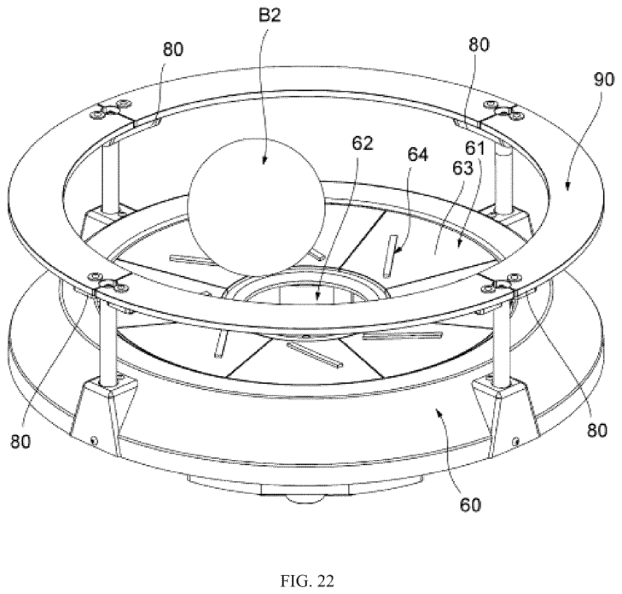

Thus, when the rotational driver 70 starts to rotate the rotary disk 61 in the first direction F1, the ball B2 placed on the placement surface 63 of the rotary disk 61 undergoes the first rotation T1 in the first direction F1 due to the frictional force f1 between the ball B2 and the placement surface 63, and also undergoes the first movement M1 along the guide portion 64 to move away from the center portion 631 of the rotary disk 61. Also, when the ball B2 undergoing the first rotation T1 comes into contact with the rotation imparting member 80, the ball B2 undergoes the second rotation T2 in the second direction F2 while undergoing the first rotation T1 and the first movement M1. Also, when the ball B2 undergoes the second rotation T2, there is a decrease in the frictional force f1 that the placement surface 63 of the rotary disk 61 exerts on the ball B2. As a result, the speed of the first rotation T1 of the ball B2 decreases. After this, when the rotational driver 70 starts to rotate the rotary disk 61 in the second direction F2, the frictional force f1 between the ball B2 and the placement surface 63 decreases further, and the ball B2 undergoes the second movement along a guide portion 64. As a result, the ball B2 gradually approaches the lottery hole 62 and then drops into the lottery hole 62, as shown in FIG. 22.

### Control Unit 1D

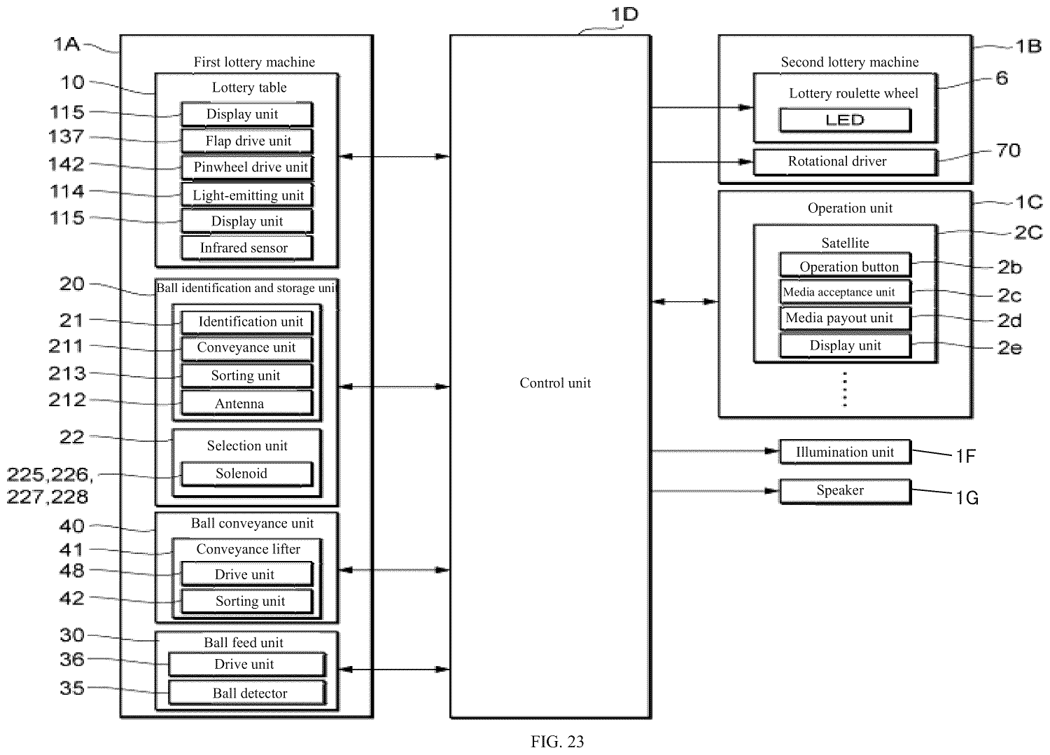

Next, the control unit 1D will be described in detail with reference to FIGS. 23 to 27.

### Functional Configuration of Control Unit 1D

The control unit 1D is configured to control the overall operation of the lottery game device 1. As shown in FIG. 23, the control unit 1D is connected to the first lottery machine 1A, the second lottery machine 1B, each of the eight satellites 2C of the operation unit 1C, the illumination unit 1F, and the speaker 1G. The control unit 1D receives time information acquired by the infrared sensor of the first lottery machine 1A, the antenna 212, the ball detector 35, each operation button 2b of the eight satellites 2C of the operation unit 1C, etc., and uses this to control the first lottery machine 1A, the second lottery machine 1B, and each of the display units 2e, illumination unit(s) 1F, speaker(s) 1G, etc., of the eight satellites 2C of the operation unit 1C, based on the data and instructions such as programs stored in the control unit 1D, and thereby executes a lottery game.

### Processing by Control Unit 1D

### Control Related to First Lottery Game

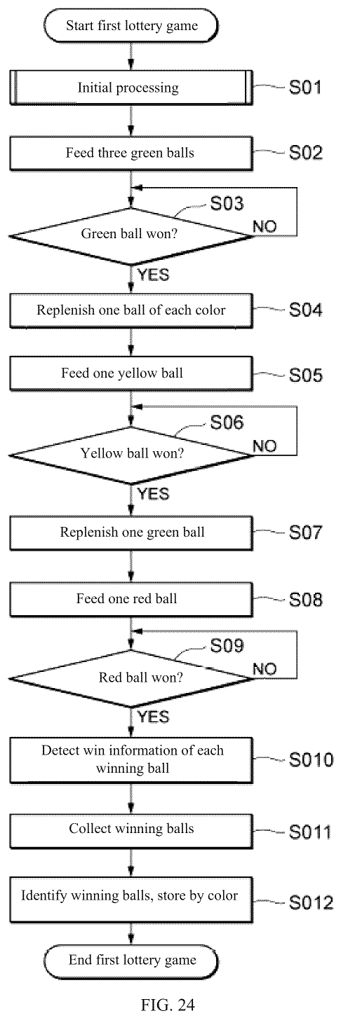

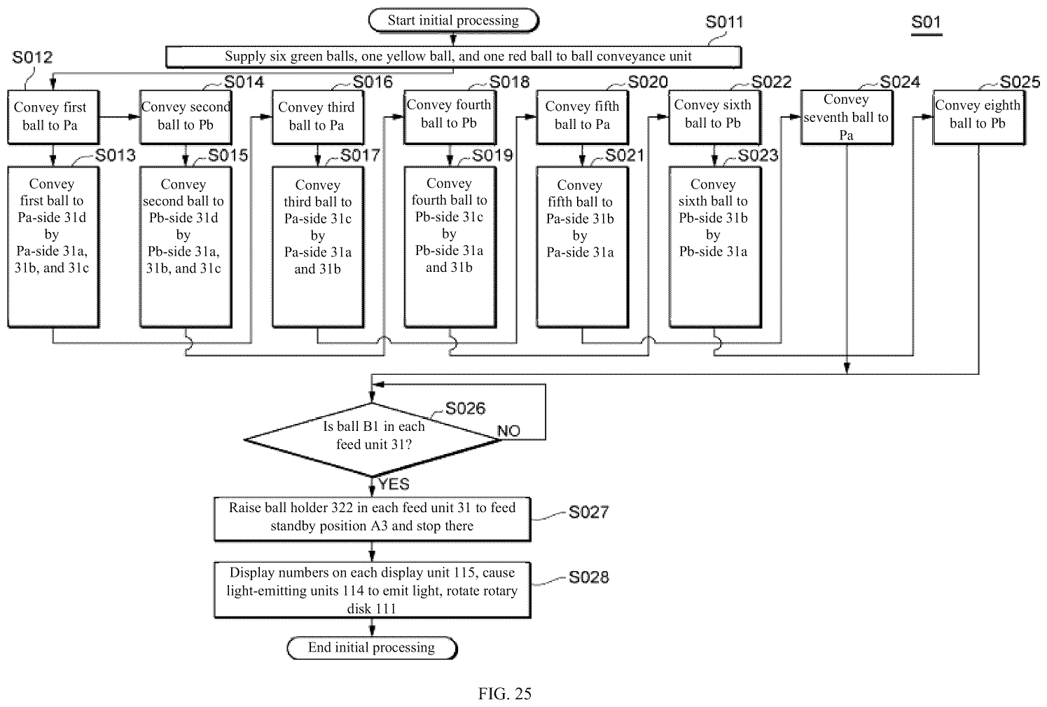

First, the control performed by the control unit 1D related to the first lottery game will be described with reference to FIGS. 24 and 25. In the following description, the configuration on the conveyance path Pa side will sometimes be referred to as the “Pa-side configuration,” and the configuration on the conveyance path Pb side as the “Pb-side configuration.”

### (Step S01)

When the control unit 1D detects a request to start the first lottery game from a satellite 2C used by a player, it first performs an initial processing (Step S01).

In step S01, as shown in FIG. 25, the control unit 1D drives each of the solenoids 225, 226, 227, and 228 of the ball identification and storage unit 20 to supply six green balls, one yellow ball, and one red ball, selected from among the balls B1 of each color stored in storage units 221, 222, 223, and 224, to the ball conveyance unit 40 (step S011). The control unit 1D then drives the ball conveyance unit 40 to sequentially convey the eight balls along the conveyance path P. Specifically, the ball conveyance unit 40 first conveys the first ball to the main conveyance path P1 on the Pa side (step S012). The first ball conveyed to the main conveyance path P1 on the Pa side advances along the main conveyance path P1 under its own weight and enters the first ball feeder 31a on the Pa side. When the first ball enters the first ball feeder 31a on the Pa side, the control unit 1D sequentially drives the respective sub-conveyance lifters 32 in each of ball feeder 31a, ball feeder 31b, and ball feeder 31c on the Pa side, thereby conveying the first ball to ball feeder 31d on the Pa side (step S013).

To explain in greater detail, in step S013, the control unit 1D first drives the sub-conveyance lifter 32 of ball feeder 31a on the Pa side to convey the first ball in ball feeder 31a to ball feeder 31b via the sub-conveyance path P2a. After the first ball is conveyed to ball feeder 31b on the Pa side, the control unit 1D drives the sub-conveyance lifter 32 of ball feeder 31b to convey the first ball in ball feeder 31b to ball feeder 31c on the Pa side via the sub-conveyance path P2b. After the first ball is conveyed to ball feeder 31c on the Pa side, the control unit 1D then drives the sub-conveyance lifter 32 of ball feeder 31c to convey the first ball in ball feeder 31c to ball feeder 31d on the Pa side via the sub-conveyance path P2c. In this manner, the control unit 1D is able to convey the first ball to ball feeder 31d, which is located at the farthest side of the conveyance path Pa, via the ball conveyance unit 40, ball feeder 31a, ball feeder 31b, and ball feeder 31c.

After conveying the first ball to the main conveyance path P1 on the Pa side, the ball conveyance unit 40 conveys the second ball to the main conveyance path P1 on the Pb side (step S014). When the second ball enters the first ball feeder 31a on the Pb side under its own weight, the control unit 1D sequentially drives the respective sub-conveyance lifters 32 in each of ball feeder 31a, ball feeder 31b, and ball feeder 31c on the Pb side, thereby conveying the second ball to ball feeder 31d on the Pb side (step S015).

Here, since the processing in step S015 is the same as the processing in step S013 above, a detailed description will be omitted. Similarly, if the processing related to the Pb side described later is the same as the processing related to the Pa side, a detailed description will be omitted. Additionally, the processing related to step S014 is performed simultaneously with the processing related to step S013. Furthermore, the processing related to step S016 is performed simultaneously with the processing related to step S015; the processing related to step S018 is performed simultaneously with the processing related to step S017; the processing related to step S020 is performed simultaneously with the processing related to step S019; the processing related to step S022 is performed simultaneously with the processing related to step S021; and the processing related to step S024 is performed simultaneously with the processing related to step S023.

After conveying the second ball to the main conveyance path P1 on the Pb side, the ball conveyance unit 40 conveys the third ball to the main conveyance path P1 on the Pa side (step S016). When the third ball enters the first ball feeder 31a on the Pa side under its own weight, the control unit 1D sequentially drives the respective sub-conveyance lifters 32 in each of ball feeder 31a and ball feeder 31b on the Pa side, thereby conveying the third ball to ball feeder 31c on the Pa side (step S017). Here, since the conveyance of the third ball to ball feeder 31c on the Pa side via ball feeders 31a and 31b is the same as the conveyance of the third ball to ball feeder 31c on the Pa side via ball feeders 31a and 31b described in step S013 above, a detailed description will be omitted.

After conveying the third ball to the main conveyance path P1 on the Pa side, the ball conveyance unit 40 conveys the fourth ball to the main conveyance path P1 on the Pb side (step S018). When the fourth ball enters the first ball feeder 31a on the Pb side under its own weight, the control unit 1D sequentially drives the respective sub-conveyance lifters 32 in each of ball feeder 31a and ball feeder 31b on the Pb side, thereby conveying the fourth ball to ball feeder 31c on the Pb side (step S019).

After conveying the fourth ball to the main conveyance path P1 on the Pb side, the ball conveyance unit 40 conveys the fifth ball to the main conveyance path P1 on the Pa side (step S020). When the fifth ball enters the first ball feeder 31a on the Pa side under its own weight, the control unit 1D drives the sub-conveyance lifter 32 in ball feeder 31a on the Pa side to convey the fifth ball to ball feeder 31b on the Pa side (step S021).

After conveying the fifth ball to the main conveyance path P1 on the Pa side, the ball conveyance unit 40 conveys the sixth ball to the main conveyance path P1 on the Pb side (step S022). When the sixth ball enters the first ball feeder 31a on the Pb side under its own weight, the control unit 1D drives the sub-conveyance lifter 32 in ball feeder 31a on the Pb side to convey the sixth ball to ball feeder 31b on the Pb side (step S023).

After conveying the sixth ball to the main conveyance path P1 on the Pb side, the ball conveyance unit 40 conveys the seventh ball to the main conveyance path P1 on the Pa side (step S024). The seventh ball then enters the first ball feeder 31a on the Pa side under its own weight.

After conveying the seventh ball to the main conveyance path P1 on the Pa side, the ball conveyance unit 40 conveys the eighth ball to the main conveyance path P1 on the Pb side (step S025). The eighth ball then enters the first ball feeder 31a on the Pb side under its own weight.

After conveying the eighth ball to the main conveyance path P1 on the Pa side, the control unit 1D determines whether or not there is a ball B1 in each of the ball feeders 31 on both the Pa and Pb sides (step S026). If it is determined that there is a ball B1 in each ball feeder 31 (YES in step S026), the control unit 1D drives and stops the sub-conveyance lifters 32 in each ball feeder 31 such that the ball holders 322 in each ball feeder 31 rise to the feed standby position A3 (step S027). The control unit 1D then displays a number on each display unit 115, causes each light-emitting unit 114 to randomly emit full-color light by combining colors such as red, blue, green, and yellow, and rotates the rotary disk 111 (step S028), thereby completing the initial processing.

On the other hand, if it is determined that there is not a ball B1 in any of the ball feeders 31 (NO in step S026), the control unit 1D returns to the processing to step S026.

In the description of the initial processing above, the processing related to step S028 was described as being performed after the processing related to steps S011 through S026. However, this is not limited to that sequence. The processing related to step S028 may also be performed before or simultaneously with the processing related to steps S011 through S026.

### (Steps S02 to S04)

The description will now return to FIG. 24. After completing the initial processing, the control unit 1D selects three ball feeders 31 from among the six ball feeders 31 holding green balls B1 and drives the sub-conveyance lifters 32 in each of the selected three ball feeders 31 so that the ball holders 322 in those three ball feeders 31 rise to the feed position A4, which causes the three green balls B1 to be fed into the lottery table 10 (step S02). After the three green balls B1 have been fed, the control unit 1D determines whether or not the three green balls B1 rolled into holes 113, thereby resulting in a win (step S03). If it is determined that the three green balls B1 resulted in a win (YES in step S03), the control unit 1D replenishes one ball B1 of each color into the three ball feeders 31 that had fed the green balls B1 (step S04). On the other hand, if it is determined that at least one of the three green balls B1 has not yet resulted in a win (NO in step S03), the control unit 1D returns the processing to step S03.

### (Steps S05 to S07)

After replenishing one ball B1 of each color, the control unit 1D selects one ball feeder 31 from among the two ball feeders 31 holding yellow balls B1 and drives the sub-conveyance lifter 32 of the selected ball feeder 31 so that the ball holder 322 in that ball feeder 31 rises to the feed position A4, thereby feeding one yellow ball B1 into the lottery table 10 (step S05). After one yellow ball B1 has been fed, the control unit 1D determines whether or not the one yellow ball B1 rolled into a hole 113, thereby resulting in a win (step S06). If it is determined that the one yellow ball B1 resulted in a win (YES in step S06), the control unit 1D replenishes one green ball B1 into the ball feeder 31 from which the yellow ball B1 was fed (step S07). On the other hand, if it is determined that the one yellow ball B1 has not resulted in a win (NO in step S06), the control unit 1D returns the processing to step S06.

### (Steps S08 to S010)

After replenishing one green ball B1, the control unit 1D selects one ball feeder 31 from among the two ball feeders 31 holding red balls B1 and drives the sub-conveyance lifter 32 of the selected ball feeder 31 so that the ball holder 322 in that ball feeder 31 rises to the feed position A4, thereby feeding one red ball B1 into the lottery table 10 (step S08). After the one red ball B1 has been fed, the control unit 1D determines whether or not the one red ball B1 rolled into a hole 113, thereby resulting in a win (step S09). If it is determined that the one red ball B1 resulted in a win (YES in step S09), the control unit 1D detects the winning information for each ball B1 that resulted in a win (step S010). Here, the winning information includes the numerical information corresponding to the hole 113 into which each ball B1 has entered and whether or not the color of the ball B1 that entered the hole 113 matches the color of the light emitted by the light-emitting unit 114 attached to that hole 113. On the other hand, if it is determined that the one red ball B1 has not resulted in a win (NO in step S09), the control unit 1D returns the processing to step S09.

### (Steps S011, S012)

Subsequently, the control unit 1D collects the balls B1 that resulted in a win (step S011). Specifically, the control unit 1D first drives the flap 136 to open the collection groove 53 of the ball collection unit 50. Then, as the control unit 1D rotates the rotary disk 111, the balls B1 in the holes 113 of the rotary disk 111 drop from the holes 113 into the collection groove 53 as they pass over the collection groove 53. The balls B1 that have dropped into the collection groove 53 move under their own weight, via the collection groove 53, to the main collection tube 51 and enter the ball identification and storage unit 20. The control unit 1D then receives the identification information for each ball B1 identified by the identification unit 21 of the ball identification and storage unit 20 and, after determining the color of each ball B1 based on that identification information, stores each ball B1 by color in the corresponding storage units 222, 223, and 224 of the selection unit 22 of its own color of each ball B1 (step S012), thereby completing the first lottery game processing.

### Control Related to Game Cancellation and Collection Processing

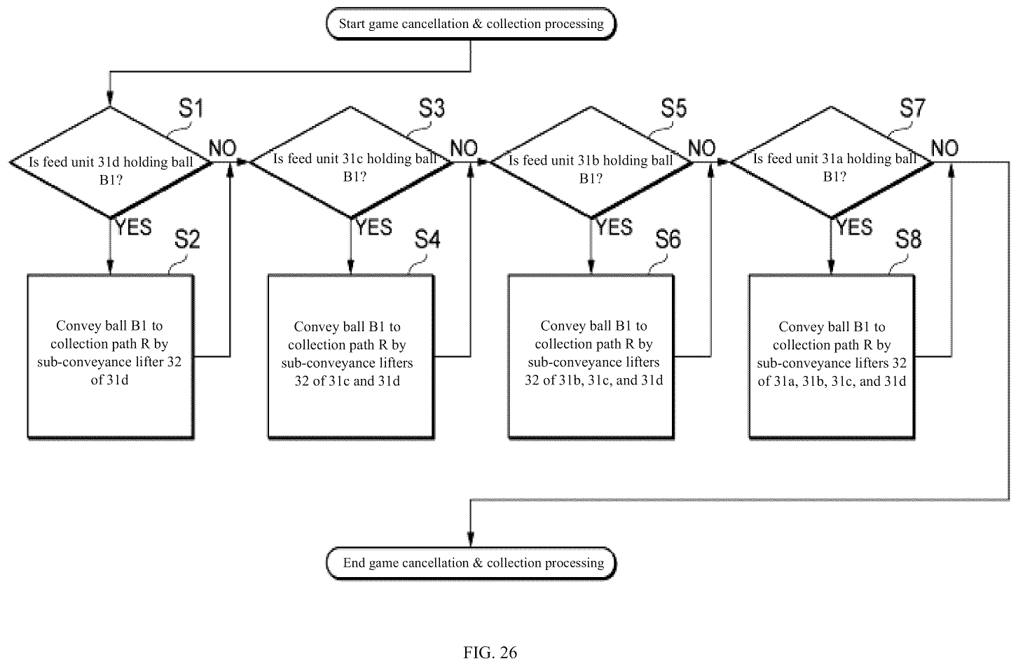

Next, the control performed by the control unit 1D related to game cancellation and collection processing will be described with reference to FIG. 26. When the control unit 1D detects a cancellation request for the first lottery game from a satellite 2C used by a player, it executes control related to game cancellation and collection processing to collect the balls B1 in each ball feeder 31. The control related to game cancellation and collection processing can be performed during or after the execution of the initial processing related to the first lottery game control (step S01), the processing to replenish one ball B1 of each color (step S04), the processing to replenish one ball B1 (step S07), and the processing to collect the balls B1 that resulted in a win (step S011).

### (Steps S1, S2)

The control unit 1D first determines whether or not ball feeder 31d is holding a ball B1 (step S1). If it is determined that ball feeder 31d is holding a ball B1 (YES in step S1), the control unit 1D drives the conveyance lifter 32 of ball feeder 31d to convey the ball B1 in ball feeder 31d to collection path R (step S2). The ball B1 then moves under its own weight along collection path R, enters the main collection tube 51, and is collected by the ball identification and storage unit 20.

### (Steps S3, S4)

After collecting the ball B1 in ball feeder 31d, the control unit 1D determines whether or not ball feeder 31c is holding a ball B1 (step S3). If it is determined that ball feeder 31c is holding a ball B1 (YES in step S3), the control unit 1D drives the conveyance lifter 32 of ball feeder 31c to convey the ball B1 in ball feeder 31c to ball feeder 31d, and then drives the conveyance lifter 32 of ball feeder 31d to convey the ball B1 in ball feeder 31d to collection path R (step S4). The ball B1 then moves under its own weight along collection path R, enters the main collection tube 51, and is collected by the ball identification and storage unit 20.

### (Steps S5, S6)

After collecting the ball B1 in ball feeder 31c, the control unit 1D determines whether or not ball feeder 31b is holding a ball B1 (step S5). If it is determined that ball feeder 31b is holding a ball B1 (YES in step S5), the control unit 1D drives the conveyance lifter 32 of ball feeder 31b to convey the ball B1 in ball feeder 31b to ball feeder 31c, then drives the conveyance lifter 32 of ball feeder 31c to convey the ball B1 in ball feeder 31c to ball feeder 31d, and then drives the conveyance lifter 32 of ball feeder 31d to convey the ball B1 in ball feeder 31d to collection path R (step S6). The ball B1 then moves under its own weight along collection path R, enters the main collection tube 51, and is collected by the ball identification and storage unit 20.

### (Steps S7, S8)

After collecting the ball B1 in ball feeder 31b, the control unit 1D determines whether or not ball feeder 31a is holding a ball B1 (step S7). If it is determined that ball feeder 31a is holding a ball B1 (YES in step S7), the control unit 1D drives the conveyance lifter 32 of ball feeder 31a to convey the ball B1 in ball feeder 31a to ball feeder 31b, then drives the conveyance lifter 32 of ball feeder 31b to convey the ball B1 in ball feeder 31b to ball feeder 31c, then drives the conveyance lifter 32 of ball feeder 31c to convey the ball B1 in ball feeder 31c to ball feeder 31d, and then drives the conveyance lifter 32 of ball feeder 31d to convey the ball B1 in ball feeder 31d to collection path R (step S8). The ball B1 then moves under its own weight along collection path R, enters the main collection tube 51, and is collected by the ball identification and storage unit 20.

Once the collection of all balls B1 in the ball feeders 31 is thus complete, the control unit 1D terminates the control related to game cancellation and collection processing.

On the other hand, if it is determined that ball feeder 31d is not holding a ball B1 (NO in step S1), the control unit 1D proceeds to step S3. Similarly, if it is determined that ball feeder 31c is not holding a ball B1 (NO in step S3), the control unit 1D proceeds to step S5. Additionally, if it is determined that ball feeder 31b is not holding a ball B1 (NO in step S5), the control unit 1D proceeds to step S7.

### Control Related to Second Lottery Game

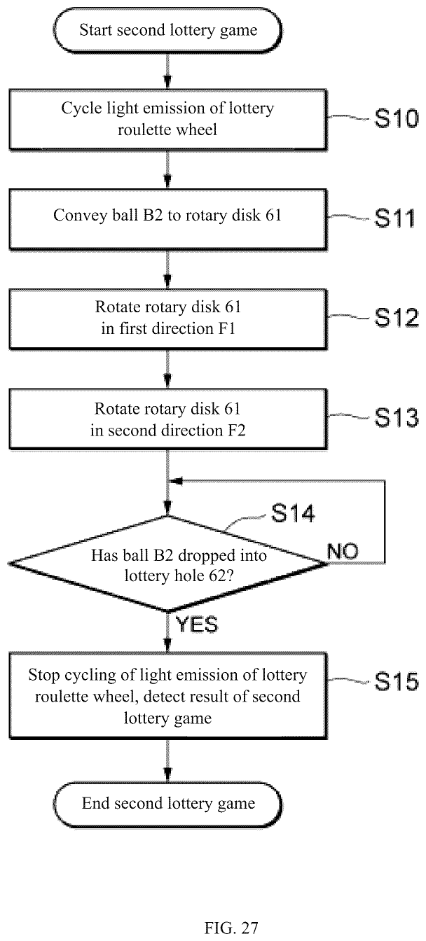

Next, the control performed by control unit 1D related to the second lottery game will be described with reference to FIG. 27.

When the control unit 1D detects a start request for the second lottery game from a satellite 2C used by a player, it causes the LEDs of the lottery roulette wheel 6 to emit light in circulation (step S10) and drives the conveyance unit 100 to convey the ball B2 stored in the lottery hole 62 to the rotary disk 60 (step S20). Then, the control unit 1D rotates the rotary disk 60 in the first direction F1 to cause the ball B2 to begin the first rotation T1 and the first movement M1 and then causes the ball B2 to begin the second rotation T2 (step S12) through contact of the ball B2 with the rotation imparting member 80. Next, the control unit 1D rotates the rotary disk 60 in the second direction F2, decelerating the first rotation T1 of the ball B2 and causing the ball B2 to begin the second movement M2 (step S13). The control unit 1D then determines whether or not the ball B2 has dropped into the lottery hole 62 (step S14). If it is determined that the ball B2 has dropped into the lottery hole 62 (YES in step S14), the control unit 1D stops the circulation of the LED lighting of the lottery roulette wheel 6, detects the result of the second lottery corresponding to the position of the LED light (step S15), and terminates the control related to the second lottery game.

The lottery device 1 according to the embodiments described above includes a lottery table 60 having a rotary disk 61 on which a ball B2 is placed and a lottery hole 62 formed in the center of the rotary disk 61, through which the ball B2 can drop; a rotational driver 70 configured to rotate the ball B2 placed on the rotary disk 61 in a first direction F1 by rotating the rotary disk 61 in the first direction F1; and a rotation imparting member 80 configured to apply an external force to the ball B2 rotating in the first direction F1, thereby rotating the ball B2 in a second direction F2 while maintaining the rotation of the ball B2 in the first direction F1, wherein the rotation of the ball B2 in the first direction F1 is the first rotation T1 in which the ball B2 rotates around the first rotation axis L1, which is the rotation axis of the rotary disk 61, and the rotation of the ball B2 in the second direction F2 is the second rotation T2 in which the ball B2 rotates around the second rotation axis L2, which is the center axis passing through the center of the ball B2. As a result, using a simple configuration, it is possible to introduce variability into the movement of the ball B2 on the rotary disk 61, thereby extending the period during which the movement of the ball B2 is particularly captivating, and thus increasing the player's anticipation for the lottery and the entertainment value of the lottery game.

Also, in the lottery device 1 according to the embodiments described above, the rotary disk 61 has a placement surface 63 on which the ball B2 is placed, the placement surface 63 is inclined so that the ball B2 moves, while rotating, from a peripheral edge portion 632 of the placement surface 63 toward a center portion 631 and drops into the lottery hole 62, and the second direction F2 is different from the first direction F1. As a result, it is possible to easily ensure that the ball B2 does not drop into the lottery hole 62 too quickly while it is rotating.

Also, in the lottery device 1 according to the embodiments described above, the first direction F1 and the second direction F2 are each either clockwise or counterclockwise, and the rotational driver 70 rotates the rotary disk 61 in the first direction F1 and then in the second direction F2. As a result, it is possible to increase the variability in the amount of time of the ball spends on the agitation surface, and the movement in the vicinity of the lottery openings can be made more random.

Also, in the lottery device 1 according to the embodiments described above, the rotary disk 61 has the placement surface 63 on which the ball B2 is placed, the placement surface 63 has a guide portion 64 that guides the movement of the ball B2 between the peripheral edge portion 632 and the center portion 631 of the placement surface 63, and when the rotary disk 61 is rotating in the first direction F1, the guide portions 64 guide the first movement M1 of the ball B2 so that the ball B2 moves away from the center portion 631 along the guide portion 64 while maintaining the first rotation T1 and second rotation T2 of the ball B2. As a result, the ball B2 can be moved away from the lottery hole 62, and the rolling time of the ball B2 on the rotary disk 61 can be extended.

Also, in the lottery device 1 according to the embodiments described above, the rotational driver 70 rotates the rotary disk 61 in the first direction F1 and then in the second direction F2, and when the rotary disk 61 is rotating in the second direction F2, the guide portion 64 guides the second movement M2 of the ball B2 so that the ball B2 approaches the center portion 631 along the guide portion 64 while maintaining the first rotation T1 and second rotation T2 of the ball B2. As a result, it is possible to decrease the rotation speed of the ball B2 and ensure that the ball B2 does not drop into the lottery hole 62 too quickly.

Also, in the lottery device 1 according to the embodiments described above, a guiderail 90 is further disposed around the rotary disk 61 to limit the range of the first rotation T1 of the ball B2 to within the rotary disk 61 through contact with the ball B2, and at least one rotation imparting member 80 is attached to the guiderail 90. As a result, it is possible to simplify the attachment of the rotation imparting member 80.

Also, in the lottery device 1 according to the embodiments described above, the rotation imparting member 80 causes the second rotation T2 of the ball B2 by using frictional force generated by contact with the ball B2. As a result, it is possible to achieve the second rotationT2 of the ball B2 using a simple structure.

Also, in the lottery device 1 according to the embodiments described above, a conveyance unit 100 is further provided that conveys the ball B2 in the lottery hole 62 to the placement surface 63 of the rotary disk 61, wherein the conveyance unit 100 is provided to be movable in the up and down direction such that, when the rotary disk 61 starts to rotate in the first direction F1 after the ball B2 has been conveyed to the placement surface 63, the opening 621 of the lottery hole 62 on the rotary disk 61 side is covered so that the ball B2 will not go into the lottery hole 62, and after a predetermined time has elapsed since the start of rotation of the rotary disk 61 in the first direction, the opening 621 is opened up so that the ball B2 will drop into the lottery hole 62. As a result, the conveyance of ball B2 can be easily accomplished, and the ball B2 is less likely to drop into the lottery hole 62 at an early stage.

The lottery game device 1 according to the embodiments described above comprises a media acceptance unit 2c for accepting game media through operations by the player, a second lottery machine 1B which is an example of the above-mentioned lottery device that starts a lottery game featuring a ball when the media acceptance unit 2c receives real game media or virtual game media, and a media payout unit 2d for paying out to the player real game media or virtual game media corresponding to the lottery result based on the lottery result of the second lottery machine 1B. As a result, using a simple configuration, it is possible to introduce variability into the movement of the ball during a lottery game, thereby extending the period during which the ball's movement is particularly captivating, and thus increasing the player's anticipation for the lottery and the entertainment value of the lottery game.

The present invention is not limited to or by the embodiments described above, and suitable design changes made to the above embodiments by a person skilled in the art are also encompassed by the scope of the present invention as long as they still have the features of the present invention. That is, the elements of the embodiments described above, as well as their arrangement, material, condition, shape, size, and the like, are not limited to the examples and may be changed as needed. Also, the elements of the embodiments described above can be combined to the extent that this is technically possible, and these combinations are also encompassed by the scope of the present invention as long as they still have the features of the present invention.

### REFERENCE SIGNS LIST

1 . . . lottery device
60 . . . lottery table
61 . . . rotary disk
62 . . . lottery hole
63 . . . placement surface
70 . . . rotational driver
80 . . . rotation imparting member
90 . . . guiderail
100 . . . conveyance unit
621 . . . opening
L1 . . . first rotation axis
L2 . . . second rotation axis

What is claimed is:

1. A lottery device, comprising:
a lottery table comprising a rotary disk on which a ball is placed, wherein a lottery hole, into which the ball can drop, is formed in a center of the rotary disk;
a rotational driver that drives the rotary disk in a first rotation direction such that the ball placed on the rotary disk rotates in the first rotation direction; and
a rotation imparting elastomer that applies external force on the ball to rotate in a second rotation direction while maintaining rotation of the ball in the first rotation direction, wherein
in the first rotation direction, the ball rotates around a rotation axis of the rotary disk, and
in the second rotation direction, the ball rotates around a center axis passing through a center of the ball.

2. The lottery device according to claim 1, wherein
the rotary disk has a placement surface on which the ball is placed,
the placement surface is inclined such that the ball moves, while rotating, from a peripheral edge portion of the placement surface toward a center portion of the placement surface and falls into the lottery hole.

3. The lottery device according to claim 1, wherein
the first rotation direction and the second rotation direction are each either clockwise or counterclockwise, and
the rotational driver drives the rotary disk to rotate in the first rotation direction and then in the second rotation direction.

4. The lottery device according to claim 1, wherein
the rotary disk has a placement surface on which the ball is placed,
the placement surface has a guide portion that guides movement of the ball between a peripheral edge portion and a center portion of the placement surface, and
the guide portion guides a first movement of the ball during rotation of the rotary disk in the first rotation direction such that the ball moves away from the center portion along the guide portion while maintaining the first rotation and the second rotation of the ball.

5. The lottery device according to claim 4, wherein
the rotational driver rotates the rotary disk in the first rotation direction and then in the second rotation direction, and
the guide portion guides a second movement of the ball during rotation of the rotary disk in the second rotation direction such that the ball approaches the center portion along the guide portion while maintaining the first rotation and the second rotation of the ball.

6. The lottery device according to claim 5, further comprising
a guiderail disposed around the rotary disk to limit a range of the first rotation of the ball to within the rotary disk through contact with the ball, and
the rotation imparting elastomer is attached to the guiderail.

7. The lottery device according to claim 6, wherein
the rotation imparting elastomer causes the second rotation of the ball by using a frictional force generated by the contact with the ball.

8. The lottery device according to claim 6, further comprising
a conveyance unit that conveys the ball in the lottery hole to the placement surface of the rotary disk, wherein
the conveyance unit is movable in an up and down direction to:
in response to the rotary disk starting to rotate in the first rotation direction after the ball has been conveyed to the placement surface, cover an opening of the lottery hole on a rotary disk side to prevent the ball from entering the lottery hole, and
after a predetermined time has elapsed since start of the rotation of the rotary disk in the first rotation direction, open the opening to allow the ball to drop into the lottery hole.

9. A lottery game device, comprising:
a media acceptance unit that receives game media through operations by a player,
the lottery device according to claim 1 in which a lottery game featuring a ball is started in response to the media acceptance unit receiving the game media, and
a media payout unit that pays out to the player game media corresponding to a lottery result obtained by the lottery device.
